(19) United States
(12) Patent Application Publication
(10) Pub. No.: US 2021/0089997 A1
(43) Pub. Date: Mar. 25, 2021

(54) LOCATION-BASED WORK ASSIGNMENT APPARATUS, SYSTEM AND METHOD

(71) Applicants: Gilad Klibanov, Oak Park, CA (US); Yanir Klibanov, Oak Park, CA (US)

(72) Inventors: Gilad Klibanov, Oak Park, CA (US); Yanir Klibanov, Oak Park, CA (US)

(21) Appl. No.: 17/026,273

(22) Filed: Sep. 20, 2020

Related U.S. Application Data
(60) Provisional application No. 62/903,663, filed on Sep. 20, 2019.

(51) Int. Cl. G06Q 10/06; G06Q 10/10; G08B 5/22; G06Q 50/30

(52) U.S. Cl. CPC G06Q 10/063114; G06Q 50/30; G08B 5/224; G06Q 10/1097

(57) ABSTRACT

Apparatus and associated methods relate to assigning a job to a worker remote from a user's job location, with the job defined by beginning and ending locations, in response to the user's request, and at a location and time based on worker location. In an illustrative example, the user may be a homeowner. The job may be, for example, moving the homeowner's trash receptacle to the street, permitting collection of the user's trash. In some examples, a potential worker may be notified of an available job via a mobile device adapted to allow the homeowner to post an available job. Some embodiments may select a potential worker to be notified based on the worker's proximity to the job location. Various examples may advantageously notify potential workers of available jobs one at a time in predetermined order, permitting each potential worker a predetermined time period to accept or decline the work.

### RELATED APPLICATIONS

This application claims the benefit of U.S. Provisional Application No. 62/903,663 filed Sep. 20, 2019, the content of which is incorporated by this reference in its entirety for all purposes as if fully set forth herein.

### TECHNICAL FIELD

Various embodiments relate generally to assigning work to a worker based on the worker location.

### BACKGROUND

Work is the effort needed to achieve an objective. Work may be quantified physically, for example in terms of the transfer of mechanical or electrical energy. Some work may involve energy expended over a period of time. Work may be performed by human workers, or machines. In an illustrative example, machines designed as robotic assistants may facilitate achieving various work objectives. For example, in some scenarios, an autonomous vehicle may be able to deliver a product to a residence, or retrieve an item for purchase from a store, without human intervention.

The effort associated with some work objectives may be physical in nature. For example, moving a woodpile from one location to another is a primarily physical task that could be assigned to a variety of potential workers based on physical strength. In some scenarios, work may be assigned to potential workers based on specific skills required to do the work. For example, a landscaping task may require particular skill manipulating various plant or soil work elements. In an illustrative example, some work may be assigned to a potential worker based on potential worker location relative to the work to be performed.

Some work may require effort expended across multiple locations. For example, a home moving company tasked to transport personal belongings from a customer's former residence in one place to a new residence in another place may pack and load the belongings at a first time and in the first place, and then transport, unload and unpack the belongings at a later time in the second place. In some scenarios, a worker may be assigned to a such a moving task based on the worker location, the location of the work to be performed, and the time the work is required. In an illustrative example, a work customer needing to hire a worker to complete a job requiring work at more than one location and time may expend significant time and effort coordinating one or more worker to complete such a task that may be distributed in space and time.

### SUMMARY

Apparatus and associated methods relate to assigning a job to a worker remote from a user's job location, with the job defined by beginning and ending locations, in response to the user's request, and at a location and time based on worker location. In an illustrative example, the user may be a homeowner. The job may be, for example, moving the homeowner's trash receptacle to the street, permitting collection of the user's trash. In some examples, a potential worker may be notified of an available job via a mobile device adapted to allow the homeowner to post an available job. Some embodiments may select a potential worker to be notified based on the worker's proximity to the job location. Various examples may advantageously notify potential workers of available jobs one at a time in predetermined order, permitting each potential worker a predetermined time period to accept or decline the work.

Apparatus and associated methods relate to assigning a job to a worker remote from a user's job location, with the job defined by beginning and ending locations, in response to the user's request, and at a location and time based on worker location. In an illustrative example, the user may be a homeowner. The job may be, for example, moving the homeowner's trash receptacle from a first location near the home to a second location for pickup. In some examples, the worker's completion of the job may be determined based on sensor data captured from the first and second locations. The sensor data may include, for example, accelerometer, GPS, image, or altimeter data. In some embodiments, encoded data, such as, for example, optical code data, identifying the second location or trash receptacle may be associated with data identifying the first location, advantageously permitting worker job performance and trash receptacle location tracking.

Apparatus and associated methods relate to assigning a job to a worker remote from a user's job location, with the job defined by beginning and ending locations, in response to the user's request, and at a location and time based on worker location. In an illustrative example, the user may be a homeowner. The job may be, for example, moving the homeowner's trash receptacle to the street, permitting collection of the user's trash. In some examples, a potential worker may be notified of an available job via a mobile device adapted to allow the homeowner to post an available job. Some embodiments may select potential workers to be notified in order of priority determined as a function of real-time demand predicted based on job completion in nearby locations and the worker's proximity to the predicted demand. Various examples may advantageously encourage worker availability closer to locations having higher predicted demand.

Various embodiments may achieve one or more advantages. For example, some embodiments may improve a homeowner's ease of access to trash collection. This facilitation may be a result of reducing the user's effort locating an available worker to transport the user's trash receptacle from a location near the user's home to a collection location. In some embodiments, a nearby potential worker may be automatically notified a user's trash receptacle is ready to be transported, for example, when the user opens their mobile app after taking out the trash. Such automatic notification may reduce a user's effort to schedule an available worker to transport the user's trash receptacle to the street for collection. Some embodiments may reduce a user's exposure to the risk their trash receptacle may be stolen or damaged while at the street after collection. Such reduced risk of trash receptacle theft or damage may be a result of automatically scheduling an available worker to transport the user's trash receptacle from the street back to the home after collection, reducing the time the trash receptacle is unattended at the collection location. For example, in some embodiments, an available worker may be automatically scheduled to return a user's trash receptacle to their home soon after collection by a trash pickup service, improving the user's trash collection experience and enhancing neighborhood appearance by reducing the clutter of trash receptacles on the street after collection.

Some embodiments may improve a user's experience determining requested work was completed as directed. This facilitation may be a result of an improved technology to confirm a trash receptacle was transported from a pickup location near the user's home, to a collection location near the street. Some examples may confirm work completion based on tracking a work item from the pickup location to the collection location. In some implementations, improved confirmation work has been completed may be a result of associating encoded data captured from the transported work item with encoded data captured from the pickup location or collection location. For example, some embodiments may associate optical code data attached to a trash receptacle with optical code data attached to a homeowner's mailbox at the street, to indicate a worker has transported the trash receptacle to the collection location, permitting the worker to indicate the job is complete, and allowing the homeowner to authorize payment and review the worker performance. In some embodiments, a homeowner may have multiple trash or recycling receptacles each with different optical code identifying the specific trash receptacles. In an illustrative example, the effort required by a user to manage collection of different materials may be reduced. For example, a user who places trash and recyclable waste in different receptacles for collection on different days may schedule their trash and recyclable waste receptacle transport for different times, automatically notifying an available worker to move each type of receptacle at different times based on the potential worker location and the optical code identifying each specific receptacle.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an illustrative operational scenario wherein a homeowner employs an exemplary location-based work assignment system to find an available worker to complete a job, based on assigning a job to a worker remote from a user's job location, with the job defined by beginning and ending locations, in response to the user's request, and at a location and time based on worker location.

FIG. 2 depicts a schematic view of an exemplary location-based work assignment network configured to find an available worker to complete a job, based on assigning a job to a worker remote from a user's job location, with the job defined by beginning and ending locations, in response to the user's request, and at a location and time based on worker location.

FIG. 3 depicts a structural view of an exemplary user mobile device configured to find an available worker to complete a job, based on assigning a job to a worker remote from a user's job location, with the job defined by beginning and ending locations, in response to the user's request, and at a location and time based on worker location.

FIG. 4 depicts a structural view of an exemplary work assignment server configured to find an available worker to complete a job, based on assigning a job to a worker remote from a user's job location, with the job defined by beginning and ending locations, in response to the user's request, and at a location and time based on worker location.

FIG. 5 depicts an illustrative screen shot view of an exemplary mobile device user interface presenting an example introduction page.

FIGS. 6A-6H together depict various illustrative screen shot views of an exemplary mobile device user interface presenting example homeowner operations.

FIGS. 7A-7H together depict various illustrative screen shot views of an exemplary mobile device user interface presenting example driver operations.

FIGS. 8A-8F together depict various illustrative screen shot views of an exemplary mobile device user interface presenting example administrative dashboard operations.

FIG. 9 depicts an illustrative view of exemplary waste receptacles configured with identifying encoded data.

FIG. 10 depicts an illustrative process flow of an exemplary Location Based Work Coordination Engine (LBWCE) facilitating job assignment to a worker in accordance with various embodiments.

FIG. 11 depicts an illustrative process flow of an exemplary Location Based Work Coordination Engine (LBWCE) facilitating job assignment to a worker and associating data captured from a work item with data captured from job beginning and ending locations to confirm work completion, in accordance with various embodiments.

FIG. 12 depicts an illustrative process flow of an exemplary Location Based Work Coordination Engine (LBWCE) facilitating a homeowner work request in accordance with various embodiments.

FIG. 13 depicts an illustrative process flow of an exemplary Location Based Work Assignment Engine (LBWAE) facilitating finding a worker to complete a job assignment in accordance with various embodiments.

FIG. 14 depicts an illustrative process flow of an exemplary Location Based Work Assignment Engine (LBWAE) facilitating finding a worker to complete a job assignment and associating data captured from a work item with data captured from job beginning and ending locations to confirm work completion, in accordance with various embodiments.

FIG. 15 depicts an illustrative process flow of an exemplary Location Based Work Assignment Engine (LBWAE) facilitating finding a worker to complete a job assignment and reordering potential worker notification priority based on worker proximity to predicted demand, in accordance with various embodiments.

Like reference symbols in the various drawings indicate like elements.

### DETAILED DESCRIPTION OF ILLUSTRATIVE EMBODIMENTS

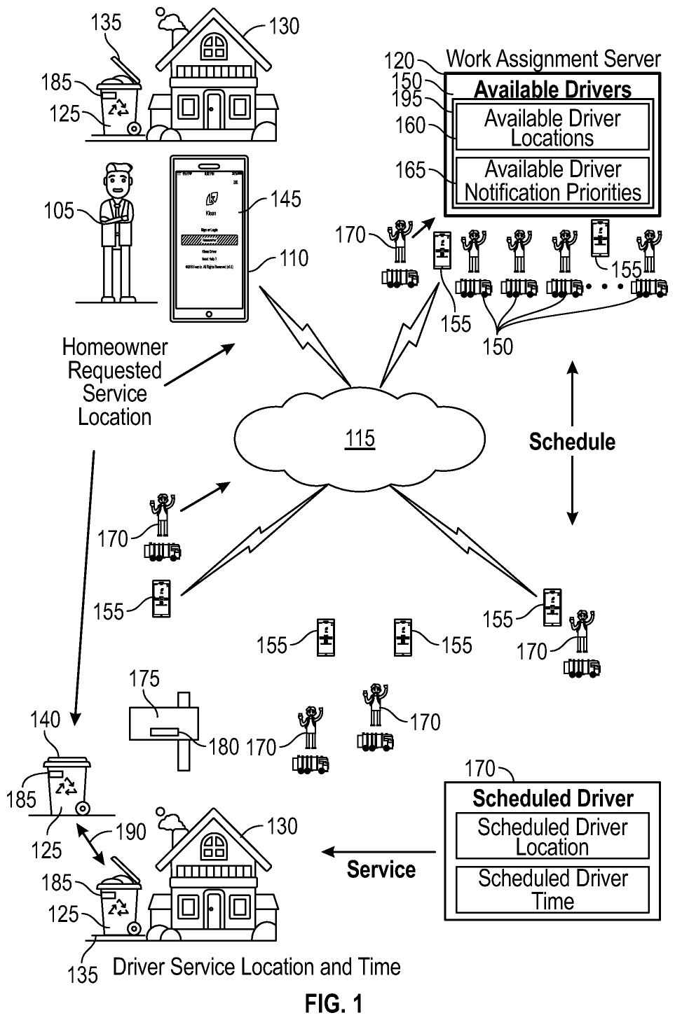

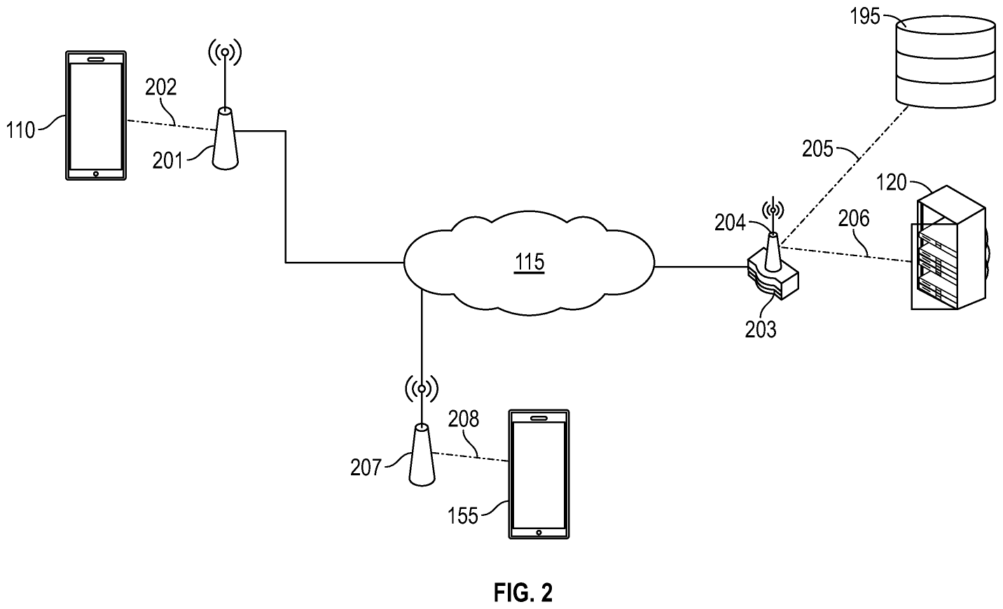

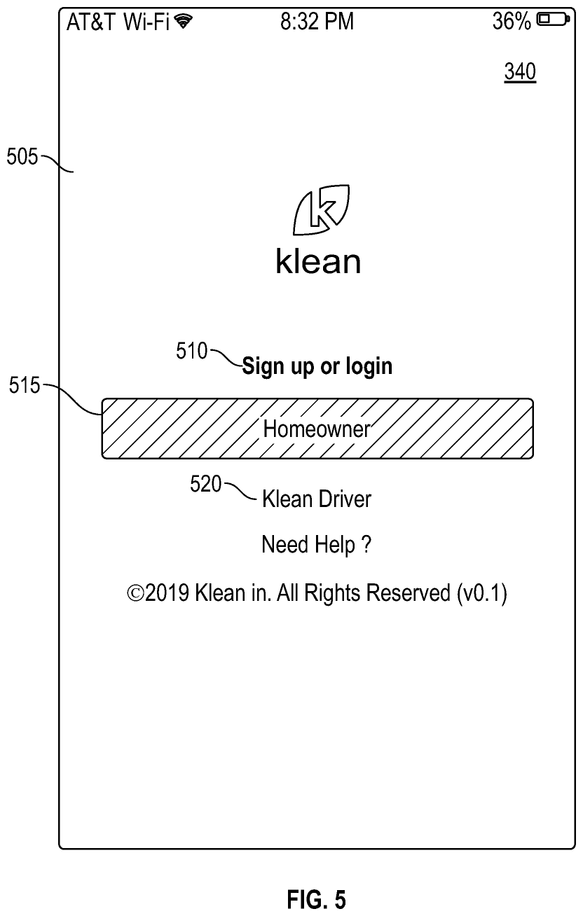

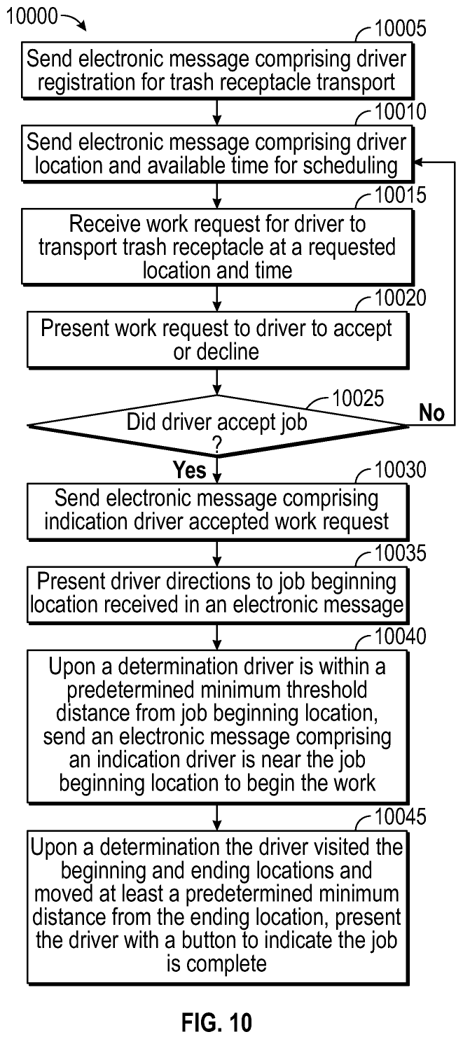

To aid understanding, this document is organized as follows. First, location based work assignment is briefly introduced with reference to FIG. 1. Second, with reference to FIGS. 2-4, the discussion turns to exemplary embodiments that illustrate improvements to location based work assignment technology. Specifically, location based work assignment network, user mobile device, and work assignment server embodiment implementations are disclosed. Then, with reference to FIGS. 5-9, illustrative operational homeowner, driver, and administrative workflows are described, with reference to embodiment device user interface screen shots and work item configurations. Finally, with reference to FIGS. 10-15, illustrative process flows exemplary of various embodiment designs are disclosed to explain improvements in location based work assignment technology.

FIG. 1 depicts an illustrative operational scenario wherein a homeowner employs an exemplary location-based work assignment system to find an available worker to complete a job, based on assigning a job to a worker remote from a user's job location, with the job defined by beginning and ending locations, in response to the user's request, and at a location and time based on worker location. In FIG. 1, the homeowner 105 uses the homeowner mobile device 110 via the network cloud 115 to submit a work request to the work assignment server 120 to transport the trash receptacle 125 from the home 130 for collection. In the depicted example, the work request includes the job beginning location 135 and the job ending location 140 entered by the homeowner 105 in the exemplary homeowner mobile device 110 including the embodiment mobile app 145. In the illustrated example, the work assignment server 120 maintains the list of available drivers 150. In some embodiments, the list of available drivers 150 may be ordered based on the available driver priority to receive a job notification. In various implementations, the driver priority to receive a job notification may be determined as a function of driver location relative to a homeowner's requested work location. In the depicted example, each of the available drivers in the list of available drivers 150 is equipped with an exemplary driver mobile device 155. In the illustrated example, the work assignment server 120 helps the homeowner 105 locate a worker to complete the homeowner's job by associating the available driver locations 160 with the homeowner's work request to find an available driver in proximity to the requested work location. In the depicted example, the work assignment server sends a job notification to one of the available drivers in the list of available drivers 150 selected according to the available driver notification priorities 165. In the illustrated example, the job notification is sent to one available driver at a time, providing each driver with a predetermined time period to accept or decline the job. In some examples, each driver may be permitted up to five minutes to accept or decline a job. In various designs, if no driver accepts or declines a job within a predetermined time period, the work assignment server 120 may send the job notification to the next driver in the list of available drivers 150. In the depicted example, upon accepting a job notification, one of the available drivers 150 becomes the scheduled driver 170 to complete the job defined by the homeowner 105 work request. In the depicted example, the work assignment server 120 assigns the scheduled driver 170 to complete the homeowner 105 work request to transport the trash receptacle 125 from the job beginning location 135 near the private home 130 to the job ending location 140 near a public street. In the illustrated example, the job ending location 140 near the public street includes the mailbox 175 configured with an optical code 180 identifying the mailbox 175 location near the public street at the home 130. In the depicted example, the scheduled driver 170 checks in at the homeowner 105 home 130 location by capturing the mailbox 175 optical code 180 with the mobile device 155. In the illustrated example, the scheduled driver 170 mobile device 155 sends the captured mailbox 175 optical code 180 data to the work assignment server 120. In the depicted embodiment, the work assignment server 120 associates the mailbox 175 optical code 180 data captured by the scheduled driver 170 with the homeowner 105 work request, and sends the homeowner 105 mobile app 145 a notification indicating the scheduled driver 170 has arrived to begin the work requested by the homeowner 105. In the illustrated embodiment, the trash receptacle 125 is configured with an optical code 185 identifying the trash receptacle 125. In the depicted embodiment, the scheduled driver 170 captures the trash receptacle 125 optical code 185 with the mobile device 155. In the illustrated embodiment, the scheduled driver 170 mobile device 155 sends the captured trash receptacle 125 optical code 185 with location data identifying the job beginning location 135 to the work assignment server 120. In various examples, the location data identifying the job beginning location 135 sent to the work assignment server 120 may be determined as a function of sensor data, including, for example, GPS sensor data. In the depicted embodiment, the work assignment server 120 associates the job beginning location 135 with the trash receptacle 125 optical code 185 to determine the scheduled driver 170 has located the correct trash receptacle in the location requested by the homeowner 105. In some examples, upon a determination the scheduled driver 170 has not located the correct trash receptacle, appropriate direction to the correct trash receptacle may be provided to the scheduled driver 170. In the illustrated embodiment, the scheduled driver 170 transports the trash receptacle 125 from the job beginning location 135 to the job ending location 140. In some examples, the scheduled driver 170 mobile device 155 may confirm the activity of the scheduled driver 170 to transport the trash receptacle based on accelerometer data captured by the mobile device 155 between the job beginning location 135 and the job ending location 140. In some examples, an embodiment mobile app may include a job setup or job demonstration mode to capture accelerometer data representative of the homeowner moving the trash receptacle to or from the street. In various examples, the accelerometer data captured while the homeowner demonstrates the job to be performed may be used to confirm an assigned worker performed the job requested. In some embodiments, the accelerometer data captured while the homeowner demonstrates the job to be performed may be used to provide a price estimate used to advertise the job to potential drivers. In various designs, the homeowner may capture an image of the beginning or ending work location, to provide a reference useful to help a driver identify the requested trash receptacle beginning or ending location. In various examples, the image of the beginning or ending work location captured by the homeowner to identify the requested trash receptacle beginning or ending location may be combined with location data to aid confirmation the work has been completed, in combination with an image captured by the driver performing the job. In the depicted embodiment, the scheduled driver 170 captures the trash receptacle 125 optical code 185 with the mobile device 155 at the job ending location 140 near a collection location at the public street. In the illustrated example, the scheduled driver 170 mobile device 155 sends the captured trash receptacle 125 optical code 185 with location data identifying the job ending location 140 to the work assignment server 120. In various examples, the location data identifying the job ending location 140 sent to the work assignment server 120 may be determined as a function of sensor data, including, for example, GPS sensor data. In the depicted embodiment, the work assignment server 120 associates the job ending location 140 and job beginning location 135 with the trash receptacle 125 optical code 185 captured at the job beginning location 135 and job ending location 140, to determine confirmation 190 the scheduled driver 170 has transported the correct trash receptacle 125 from the job beginning location 135 to the job ending location 140 requested by the homeowner 105. In the illustrated embodiment, the work assignment server 120 associates the job beginning location 135, job ending location 140, mailbox 175 optical code 180, and trash receptacle 125 optical code 185 via data records maintained in the database server 195. In various examples, the optical code 185 may be advantageously attached to any substantially moveable object transportable from the job beginning location 135 to the job ending location 140. In some examples, the optical code 180 may be advantageously attached to any object substantially fixed at the job ending location 140. In various embodiments, the job beginning location 135 and the job ending location may be interchanged.

FIG. 2 depicts a schematic view of an exemplary location-based work assignment network configured to find an available worker to complete a job, based on assigning a job to a worker remote from a user's job location, with the job defined by beginning and ending locations, in response to the user's request, and at a location and time based on worker location. In FIG. 2, according to an exemplary embodiment of the present disclosure, data may be transferred to the system, stored by the system and/or transferred by the system to users of the system across local area networks (LANs) or wide area networks (WANs). In accordance with various embodiments, the system may include numerous servers, data mining hardware, computing devices, or any combination thereof, communicatively connected across one or more LANs and/or WANs. One of ordinary skill in the art would appreciate that there are numerous manners in which the system could be configured, and embodiments of the present disclosure are contemplated for use with any configuration. Referring to FIG. 2, a schematic overview of a system in accordance with an embodiment of the present disclosure is shown. In the depicted embodiment, an exemplary system includes the exemplary homeowner mobile device 110 configured to help a homeowner find an available worker to complete a job. In the illustrated embodiment, the driver mobile device 155 is configured to facilitate job assignment to a worker and help confirm work completion. In the depicted example, the database server 195 is a network storage server configured to provide storage and retrieval access to data records including homeowner and driver account, location, and job performance data such as, for example, encoded data captured from a work item, a job beginning location, or a job ending location. In the depicted embodiment, the work assignment server 120 is a computing device configured to assign a job to a worker remote from a homeowner's job location, at a location and time based on worker location. In the illustrated embodiment, the homeowner mobile device 110 is communicatively and operably coupled by the wireless access point 201 and the wireless communication link 202 with the network cloud 115 (for example, the Internet) to send, retrieve, or manipulate information in storage devices, servers, and network components, and exchange information with various other systems and devices via the network cloud 115. In the depicted example, the illustrative system includes the router 203 configured to communicatively and operably couple the database server 195 to the network cloud 115 via the wireless access point 204 and the wireless communication link 205. In the illustrated example, the router 203 also communicatively and operably couples the work assignment server 120 to the network cloud 115 via the wireless access point 204 and the wireless communication link 206. In the depicted embodiment, the driver mobile device 155 is communicatively and operably coupled with the network cloud 115 by the wireless access point 207 and the wireless communication link 208. In various examples, one or more of: the homeowner mobile device 110, the database server 195, the work assignment server 120, or the driver mobile device 155 may include an application server configured to store or provide access to information used by the system. In various embodiments, one or more application server may retrieve or manipulate information in storage devices and exchange information through the network cloud 115. In some examples, one or more of: the homeowner mobile device 110, the database server 195, the work assignment server 120, or the driver mobile device 155 may include various applications implemented as processor-executable program instructions. In some embodiments, various processor-executable program instruction applications may also be used to manipulate information stored remotely and process and analyze data stored remotely across the network cloud 115 (for example, the Internet). According to an exemplary embodiment, as shown in FIG. 2, exchange of information through the network cloud 115 or other network may occur through one or more high speed connections. In some cases, high speed connections may be over-the-air (OTA), passed through networked systems, directly connected to one or more network cloud 115 or directed through one or more router. In various implementations, one or more router may be optional, and other embodiments in accordance with the present disclosure may or may not utilize one or more router. One of ordinary skill in the art would appreciate that there are numerous ways any or all of the depicted devices may connect with the network cloud 115 for the exchange of information, and embodiments of the present disclosure are contemplated for use with any method for connecting to networks for the purpose of exchanging information. Further, while this application may refer to high speed connections, embodiments of the present disclosure may be utilized with connections of any useful speed. In an illustrative example, components or modules of the system may connect to one or more of: the homeowner mobile device 110, the database server 195, the work assignment server 120, or the driver mobile device 155 via the network cloud 115 or other network in numerous ways. For instance, a component or module may connect to the system i) through a computing device directly connected to the network cloud 115, ii) through a computing device connected to the network cloud 115 through a routing device, or iii) through a computing device connected to the network cloud 115 through a wireless access point. One of ordinary skill in the art will appreciate that there are numerous ways that a component or module may connect to a device via network cloud 115 or other network, and embodiments of the present disclosure are contemplated for use with any network connection method. In various examples, one or more of: the homeowner mobile device 110, the database server 195, the work assignment server 120, or the driver mobile device 155 could include a personal computing device, such as a smartphone, tablet computer, wearable computing device, cloud-based computing device, virtual computing device, or desktop computing device, configured to operate as a host for other computing devices to connect to. In some examples, one or more communications means of the system may be any circuitry or other means for communicating data over one or more networks or to one or more peripheral devices attached to the system, or to a system module or component. Appropriate communications means may include, but are not limited to, wireless connections, wired connections, cellular connections, data port connections, BLUETOOTH® connections, near field communications (NFC®) connections, or any combination thereof. One of ordinary skill in the art will appreciate that there are numerous communications means that may be utilized with embodiments of the present disclosure, and embodiments of the present disclosure are contemplated for use with any communications means.

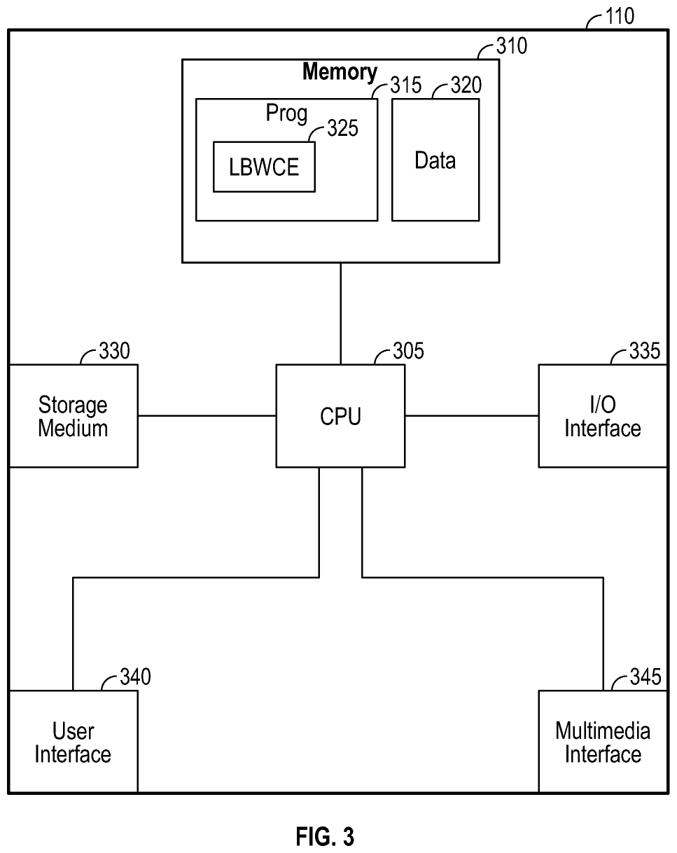

FIG. 3 depicts a structural view of an exemplary user mobile device configured to find an available worker to complete a job, based on assigning a job to a worker remote from a user's job location, with the job defined by beginning and ending locations, in response to the user's request, and at a location and time based on worker location. In FIG. 3, the block diagram of the exemplary homeowner mobile device 110 depicted at least in FIG. 1, is to be understood as also representative of the driver mobile device 155, depicted at least in FIG. 1. In the embodiment depicted by FIG. 3, the exemplary homeowner mobile device 110 and the driver mobile device 155 include processor 305 and memory 310. The processor 305 is in electrical communication with the memory 310. The depicted memory 310 includes program memory 315 and data memory 320. The depicted program memory 315 includes processor-executable program instructions implementing the Location Based Work Coordination Engine (LBWCE) 325. In some embodiments, the illustrated program memory 315 may include processor-executable program instructions configured to implement an OS (Operating System). In various embodiments, the OS may include processor executable program instructions configured to implement various operations when executed by the processor 305. In some embodiments, the OS may be omitted. In some embodiments, the illustrated program memory 315 may include processor-executable program instructions configured to implement various Application Software. In various embodiments, the Application Software may include processor executable program instructions configured to implement various operations when executed by the processor 305. In some embodiments, the Application Software may be omitted. In the depicted embodiment, the processor 305 is communicatively and operably coupled with the storage medium 330. In the depicted embodiment, the processor 305 is communicatively and operably coupled with the I/O (Input/Output) interface 335. In the depicted embodiment, the I/O interface 335 includes a network interface. In various implementations, the network interface may be a wireless network interface. In some designs, the network interface may be a Wi-Fi interface. In some embodiments, the network interface may be a BLUETOOTH® interface. In an illustrative example, the homeowner mobile device 110 or the driver mobile device 155 may include more than one network interface. In some designs, the network interface may be a wireline interface. In some designs, the network interface may be omitted. In the depicted embodiment, the processor 305 is communicatively and operably coupled with the user interface 340. In various implementations, the user interface 340 may be adapted to receive input from a user or send output to a user. In some embodiments, the user interface 340 may be adapted to an input-only or output-only user interface mode. In various implementations, the user interface 340 may include an imaging display. In some embodiments, the user interface 340 may include an audio interface. In some designs, the audio interface may include an audio input. In various designs, the audio interface may include an audio output. In some implementations, the user interface 340 may be touch-sensitive. In some designs, the homeowner mobile device 110 or the driver mobile device 155 may include an accelerometer operably coupled with the processor 305. In various embodiments, the homeowner mobile device 110 or the driver mobile device 155 may include a GPS module operably coupled with the processor 305. In an illustrative example, the homeowner mobile device 110 or the driver mobile device 155 may include a magnetometer operably coupled with the processor 305. In some embodiments, the user interface 340 may include an input sensor array. In various implementations, the input sensor array may include one or more imaging sensor. In various designs, the input sensor array may include one or more audio transducer. In some implementations, the input sensor array may include a radio-frequency detector. In an illustrative example, the input sensor array may include an ultrasonic audio transducer. In some embodiments, the input sensor array may include image sensing subsystems or modules configurable by the processor 305 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In various implementations, the depicted memory 310 may contain processor executable program instruction modules configurable by the processor 305 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In some embodiments, the input sensor array may include audio sensing subsystems or modules configurable by the processor 305 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In various implementations, the depicted memory 310 may contain processor executable program instruction modules configurable by the processor 305 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In the depicted embodiment, the processor 305 is communicatively and operably coupled with the multimedia interface 345. In the illustrated embodiment, the multimedia interface 345 includes interfaces adapted to input and output of audio, video, and image data. In some embodiments, the multimedia interface 345 may include one or more still image camera or video camera. In various designs, the multimedia interface 345 may include one or more microphone. In some implementations, the multimedia interface 345 may include a wireless communication means configured to operably and communicatively couple the multimedia interface 345 with a multimedia data source or sink external to the homeowner mobile device 110 or the driver mobile device 155. In various designs, the multimedia interface 345 may include interfaces adapted to send, receive, or process encoded audio or video. In various embodiments, the multimedia interface 345 may include one or more video, image, or audio encoder. In various designs, the multimedia interface 345 may include one or more video, image, or audio decoder. In various implementations, the multimedia interface 345 may include interfaces adapted to send, receive, or process one or more multimedia stream. In some embodiments, the multimedia interface 345 may include a hardware or software module configured to decode data encoded in visual form, such as, for example, optical code captured by an image sensor or provided as image input for decoding. In various implementations, the multimedia interface 345 may include a GPU. In some embodiments, the multimedia interface 345 may be omitted. Useful examples of the illustrated homeowner mobile device 110 or the driver mobile device 155 include, but are not limited to, personal computers, servers, tablet PCs, smartphones, or other computing devices. In some embodiments, multiple homeowner mobile device 110 or driver mobile device 155 devices may be operably linked to form a computer network in a manner as to distribute and share one or more resources, such as clustered computing devices and server banks/farms. Various examples of such general-purpose multi-unit computer networks suitable for embodiments of the disclosure, their typical configuration and many standardized communication links are well known to one skilled in the art, as explained in more detail in the foregoing FIG. 2 description. In some embodiments, an exemplary homeowner mobile device 110 or driver mobile device 155 design may be realized in a distributed implementation. In an illustrative example, some homeowner mobile device 110 or driver mobile device 155 designs may be partitioned between a client device, such as, for example, a phone, and, a more powerful server system, as depicted, for example, in FIG. 2. In various designs, a homeowner mobile device 110 or driver mobile device 155 partition hosted on a PC or mobile device may choose to delegate some parts of computation, such as, for example, machine learning or deep learning, to a host server. In some embodiments, a client device partition may delegate computation-intensive tasks to a host server to take advantage of a more powerful processor, or to offload excess work. In an illustrative example, some devices may be configured with a mobile chip including an engine adapted to implement specialized processing, such as, for example, neural networks, machine learning, artificial intelligence, image recognition, audio processing, or digital signal processing. In some embodiments, such an engine adapted to specialized processing may have sufficient processing power to implement some features. However, in some embodiments, an exemplary homeowner mobile device 110 or driver mobile device 155 may be configured to operate on a device with less processing power, such as, for example, various gaming consoles, which may not have sufficient processor power, or a suitable CPU architecture, to adequately support the homeowner mobile device 110 or the driver mobile device 155. Various embodiment designs configured to operate on a such a device with reduced processor power may work in conjunction with a more powerful server system.

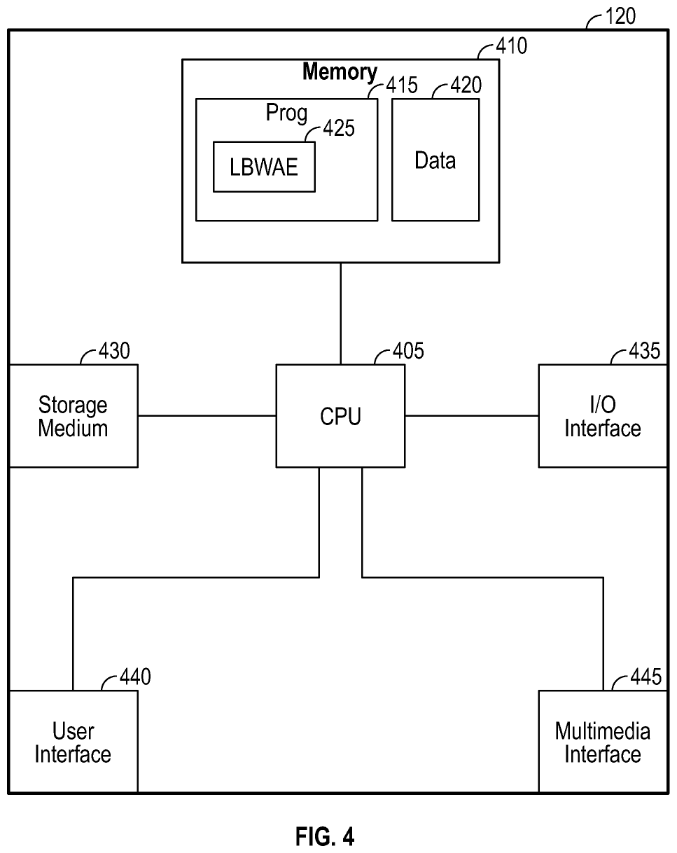

FIG. 4 depicts a structural view of an exemplary work assignment server configured to find an available worker to complete a job, based on assigning a job to a worker remote from a user's job location, with the job defined by beginning and ending locations, in response to the user's request, and at a location and time based on worker location. In FIG. 4, the block diagram of the exemplary work assignment server 120 includes processor 405 and memory 410. The processor 405 is in electrical communication with the memory 410. The depicted memory 410 includes program memory 415 and data memory 420. The depicted program memory 415 includes processor-executable program instructions implementing the Location Based Work Assignment Engine (LBWAE) 425. In some embodiments, the illustrated program memory 415 may include processor-executable program instructions configured to implement an OS (Operating System). In various embodiments, the OS may include processor executable program instructions configured to implement various operations when executed by the processor 405. In some embodiments, the OS may be omitted. In some embodiments, the illustrated program memory 415 may include processor-executable program instructions configured to implement various Application Software. In various embodiments, the Application Software may include processor executable program instructions configured to implement various operations when executed by the processor 405. In some embodiments, the Application Software may be omitted. In the depicted embodiment, the processor 405 is communicatively and operably coupled with the storage medium 430. In the depicted embodiment, the processor 405 is communicatively and operably coupled with the I/O (Input/Output) interface 435. In the depicted embodiment, the I/O interface 435 includes a network interface. In various implementations, the network interface may be a wireless network interface. In some designs, the network interface may be a Wi-Fi interface. In some embodiments, the network interface may be a BLUETOOTH® interface. In an illustrative example, the work assignment server 120 may include more than one network interface. In some designs, the network interface may be a wireline interface. In some designs, the network interface may be omitted. In the depicted embodiment, the processor 405 is communicatively and operably coupled with the user interface 440. In various implementations, the user interface 440 may be adapted to receive input from a user or send output to a user. In some embodiments, the user interface 440 may be adapted to an input-only or output-only user interface mode. In various implementations, the user interface 440 may include an imaging display. In some embodiments, the user interface 440 may include an audio interface. In some designs, the audio interface may include an audio input. In various designs, the audio interface may include an audio output. In some implementations, the user interface 440 may be touch-sensitive. In some designs, the work assignment server 120 may include an accelerometer operably coupled with the processor 405. In various embodiments, the work assignment server 120 may include a GPS module operably coupled with the processor 405. In an illustrative example, the work assignment server 120 may include a magnetometer operably coupled with the processor 405. In some embodiments, the user interface 440 may include an input sensor array. In various implementations, the input sensor array may include one or more imaging sensor. In various designs, the input sensor array may include one or more audio transducer. In some implementations, the input sensor array may include a radio-frequency detector. In an illustrative example, the input sensor array may include an ultrasonic audio transducer. In some embodiments, the input sensor array may include image sensing subsystems or modules configurable by the processor 405 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In various implementations, the depicted memory 410 may contain processor executable program instruction modules configurable by the processor 405 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In some embodiments, the input sensor array may include audio sensing subsystems or modules configurable by the processor 405 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In various implementations, the depicted memory 410 may contain processor executable program instruction modules configurable by the processor 405 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In the depicted embodiment, the processor 405 is communicatively and operably coupled with the multimedia interface 445. In the illustrated embodiment, the multimedia interface 445 includes interfaces adapted to input and output of audio, video, and image data. In some embodiments, the multimedia interface 445 may include one or more still image camera or video camera. In various designs, the multimedia interface 445 may include one or more microphone. In some implementations, the multimedia interface 445 may include a wireless communication means configured to operably and communicatively couple the multimedia interface 445 with a multimedia data source or sink external to the work assignment server 120. In various designs, the multimedia interface 445 may include interfaces adapted to send, receive, or process encoded audio or video. In various embodiments, the multimedia interface 445 may include one or more video, image, or audio encoder. In various designs, the multimedia interface 445 may include one or more video, image, or audio decoder. In various implementations, the multimedia interface 445 may include interfaces adapted to send, receive, or process one or more multimedia stream. In some embodiments, the multimedia interface 445 may include a hardware or software module configured to decode data encoded in visual form, such as, for example, optical code captured by an image sensor or provided as image input for decoding. In various implementations, the multimedia interface 445 may include a GPU. In some embodiments, the multimedia interface 445 may be omitted. Useful examples of the work assignment server 120 include, but are not limited to, personal computers, servers, tablet PCs, smartphones, or other computing devices. In some embodiments, multiple work assignment server 120 devices may be operably linked to form a computer network in a manner as to distribute and share one or more resources, such as clustered computing devices and server banks/farms. Various examples of such general-purpose multi-unit computer networks suitable for embodiments of the disclosure, their typical configuration and many standardized communication links are well known to one skilled in the art, as explained in more detail in the foregoing FIG. 2 description. In some embodiments, an exemplary work assignment server 120 design may be realized in a distributed implementation. In an illustrative example, some work assignment server 120 designs may be partitioned between a client device, such as, for example, a phone, and, a more powerful server system, as depicted, for example, in FIG. 2. In various designs, a work assignment server 120 partition hosted on a PC or mobile device may choose to delegate some parts of computation, such as, for example, machine learning or deep learning, to a host server. In some embodiments, a client device partition may delegate computation-intensive tasks to a host server to take advantage of a more powerful processor, or to offload excess work. In an illustrative example, some devices may be configured with a mobile chip including an engine adapted to implement specialized processing, such as, for example, neural networks, machine learning, artificial intelligence, image recognition, audio processing, or digital signal processing. In some embodiments, such an engine adapted to specialized processing may have sufficient processing power to implement some features. However, in some embodiments, an exemplary work assignment server 120 may be configured to operate on a device with less processing power, such as, for example, various gaming consoles, which may not have sufficient processor power, or a suitable CPU architecture, to adequately support work assignment server 120. Various embodiment designs configured to operate on a such a device with reduced processor power may work in conjunction with a more powerful server system.

FIG. 5 depicts an illustrative screen shot view of an exemplary mobile device user interface presenting an example introduction page. In FIG. 5, the exemplary mobile device user interface 340 is depicted presenting an embodiment mobile app including the illustrative application introduction page 505 permitting a user to enter the application via sign up or login 510 as Homeowner 515 or Driver 520.

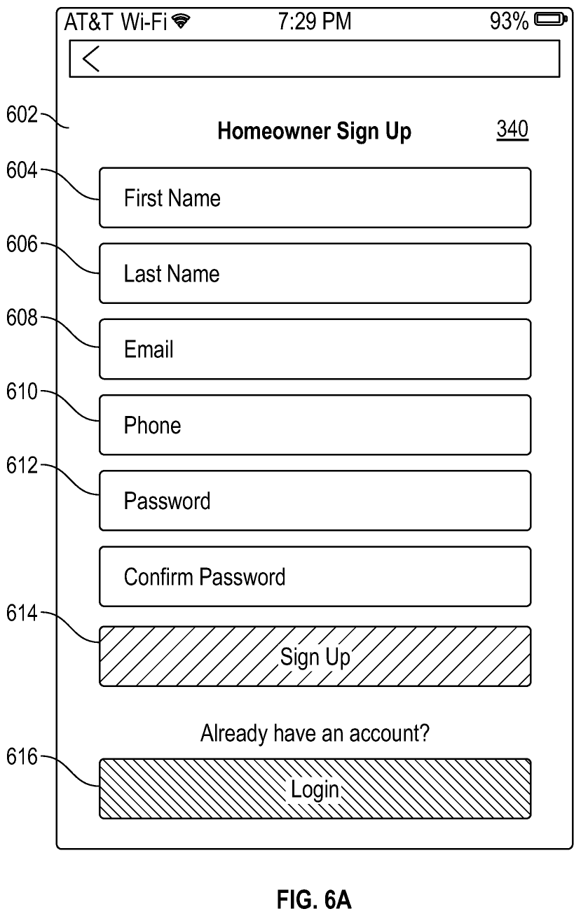

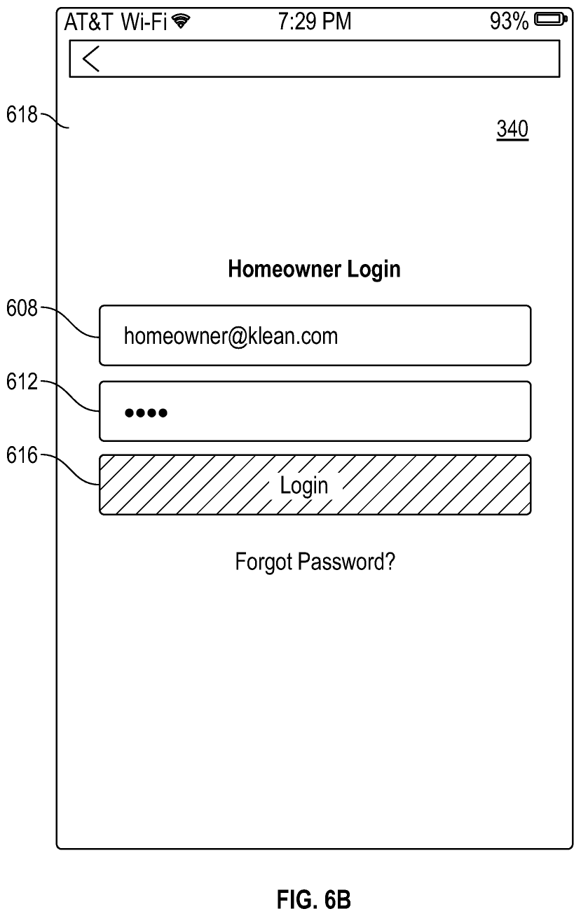

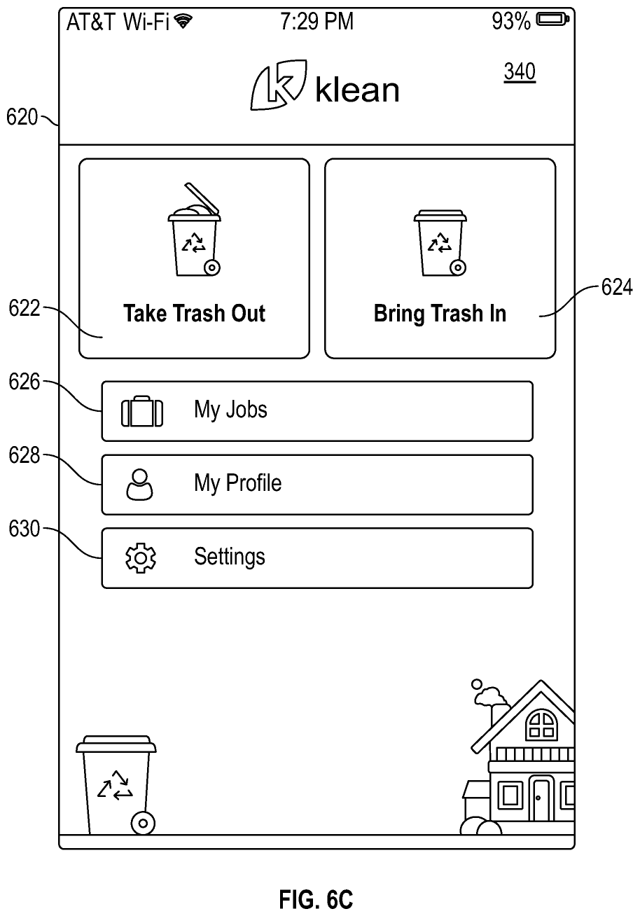

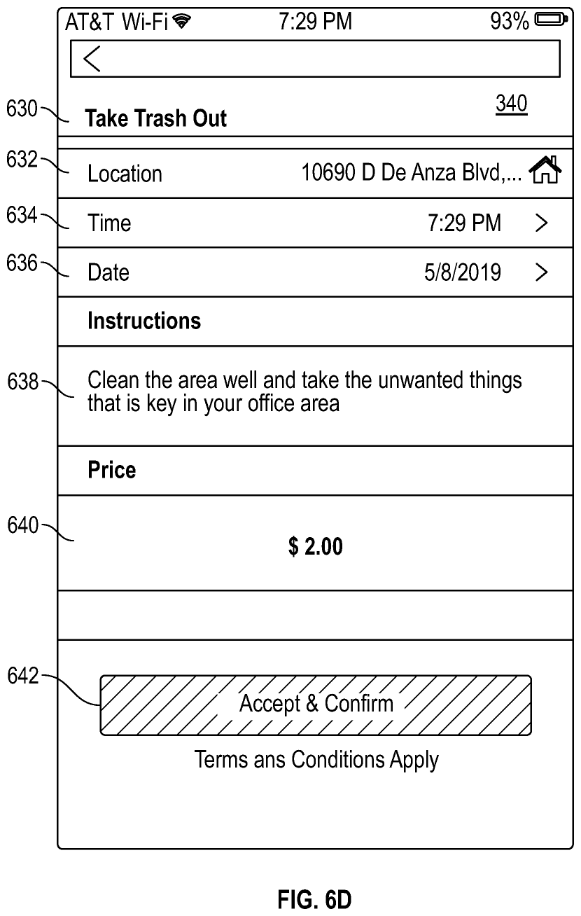

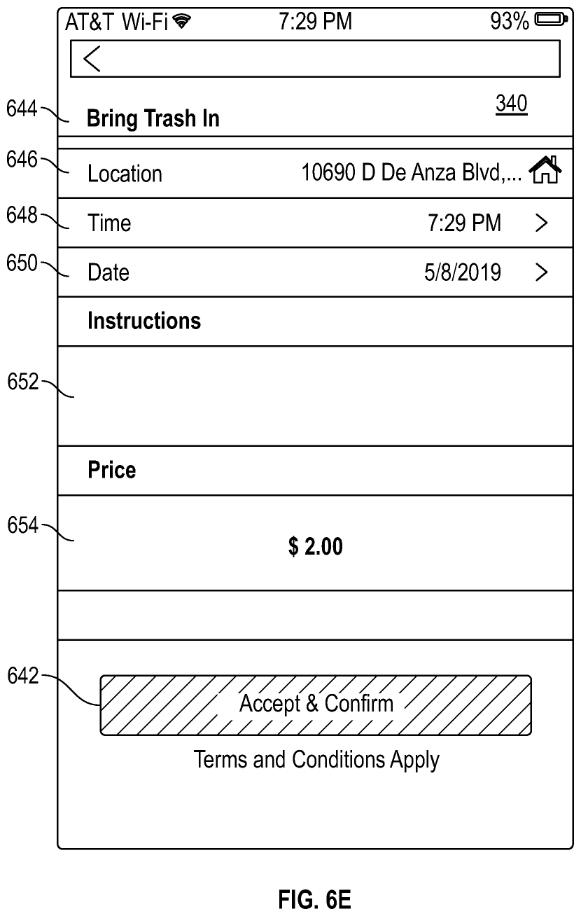

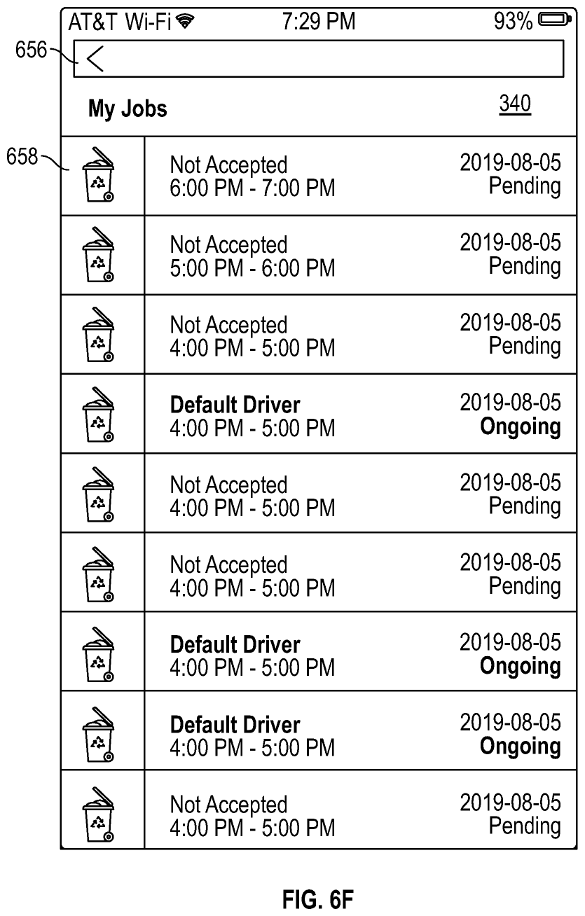

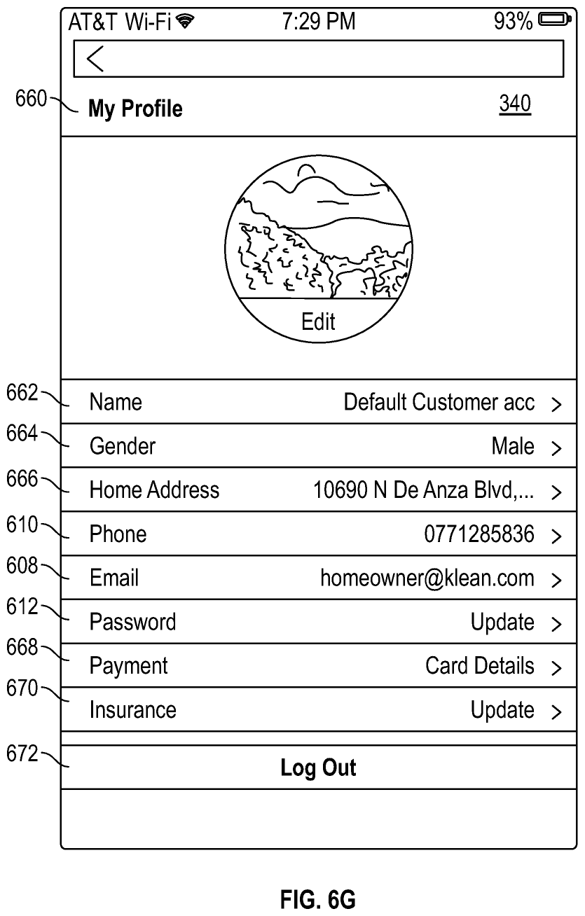

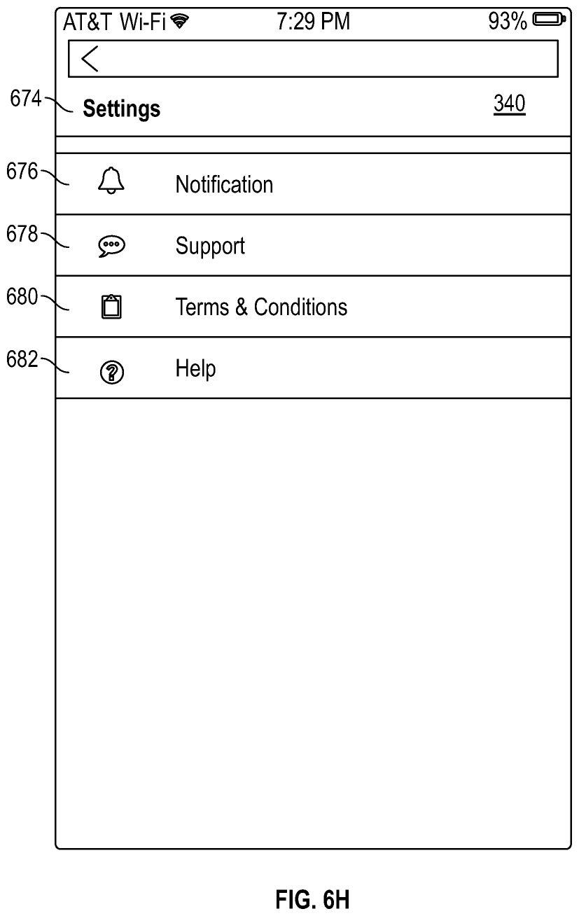

FIGS. 6A-6H together depict various illustrative screen shot views of an exemplary mobile device user interface presenting example homeowner operations.

In FIG. 6A, the exemplary mobile device user interface 340 is illustrated displaying an embodiment mobile app including the example Homeowner Sign Up screen 602. In the depicted example, the Homeowner Sign Up screen 602 includes fields for a prospective registering Homeowner user to provide First Name 604, Last Name 606, Email Address 608, Phone Number 610, and Password 612. In the illustrated example, the prospective registering Homeowner may be prompted to Confirm Password before registering via the Sign Up button 614. In some exemplary scenarios, if the Homeowner already has an account, the Homeowner may enter their Email Address 608 and Password 612, and select Login 616 to access their account.

In FIG. 6B, the exemplary mobile device user interface 340 is depicted displaying the illustrative Homeowner Login screen 618 in an embodiment mobile app. In the depicted example, a Homeowner is shown logging in to the app with the Homeowner's Email Address 608 and Password 612, before tapping Login 616 to access the Homeowner account.

In FIG. 6C, the exemplary mobile device user interface 340 is illustrated displaying the illustrative Homeowner home screen 620 in an embodiment mobile app. In the depicted embodiment, the exemplary Homeowner home screen 620 provides a registered homeowner with Take Trash Out 622 and Bring Trash In 624 options to initiate requests to have their trash receptacle transported to the street for collection or retrieved to their home. In the depicted example, a registered homeowner may access their existing jobs 626 in addition to navigating to their profile 628 and settings 630.

In FIG. 6D, the exemplary mobile device user interface 340 is depicted presenting the illustrative Homeowner Take Trash Out screen 630 in an embodiment mobile app. In the illustrated embodiment, the exemplary Homeowner Take Trash Out screen 630 includes a field for the registered homeowner to indicate their work location 632. In various examples, the work location 632 may be provided by sensor data captured from a location sensor. In the depicted example the illustrative Homeowner Take Trash Out screen 630 also includes fields for the registered homeowner to provide the requested work time 634, requested date 636, instructions 638, and the price 640 the homeowner is willing to pay for the job, before tapping Accept & Confirm 642 to submit the Take Trash Out work request.

In FIG. 6E, the illustrative mobile device user interface 340 is illustrated displaying the exemplary Homeowner Bring Trash In screen 644 in an embodiment mobile app. In the depicted embodiment, the exemplary Homeowner Bring Trash In screen 644 includes fields for the registered homeowner to indicate their work location 646, requested work time 648, requested date 650, instructions 652, and the price 654 the homeowner is willing to pay for the job, before tapping Accept and Confirm 642 to submit the Bring Trash In work request. In some embodiments, the work location 646 may be provided by sensor data captured from a location sensor.

In FIG. 6F, the exemplary mobile device user interface 340 is depicted presenting the illustrative Homeowner My Jobs screen 656 in an embodiment mobile app. In the illustrated embodiment, the exemplary Homeowner My Jobs screen 656 presents the registered homeowner with detailed jobs listing 658 of the homeowner's work requests including the date, time, and status of each work request.

In FIG. 6G, the illustrative mobile device user interface 340 is illustrated displaying the exemplary Homeowner Profile screen 660 in an embodiment mobile app. In the depicted embodiment, the exemplary Homeowner Profile screen 660 permits the registered homeowner to edit Account Profile data including Account Name 662, Gender 664, Home Address 666, Phone Number 610, Email Address 608, Password 612, Payment Card Details 668, and Insurance 670. In the depicted example the Homeowner Profile screen 660 also permits the registered homeowner to Log Out 672 after accessing the account profile data.

In FIG. 6H, the exemplary mobile device user interface 340 is depicted presenting the illustrative Homeowner Settings screen 674 in an embodiment mobile app. In the depicted embodiment, the exemplary Homeowner Settings screen 674 permits the registered homeowner to edit settings including Notification 676, in addition to providing access to Support 678, Terms & Conditions 680, and Help 682.

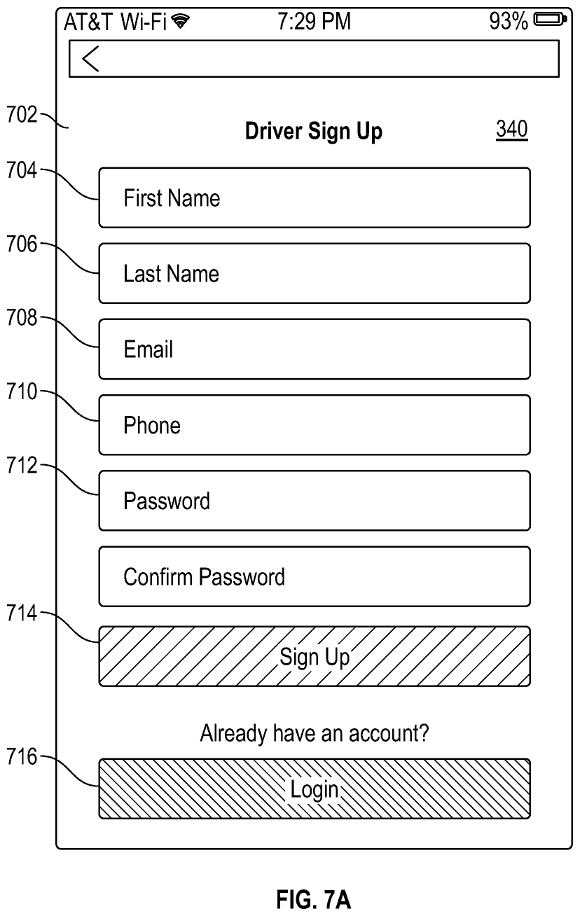

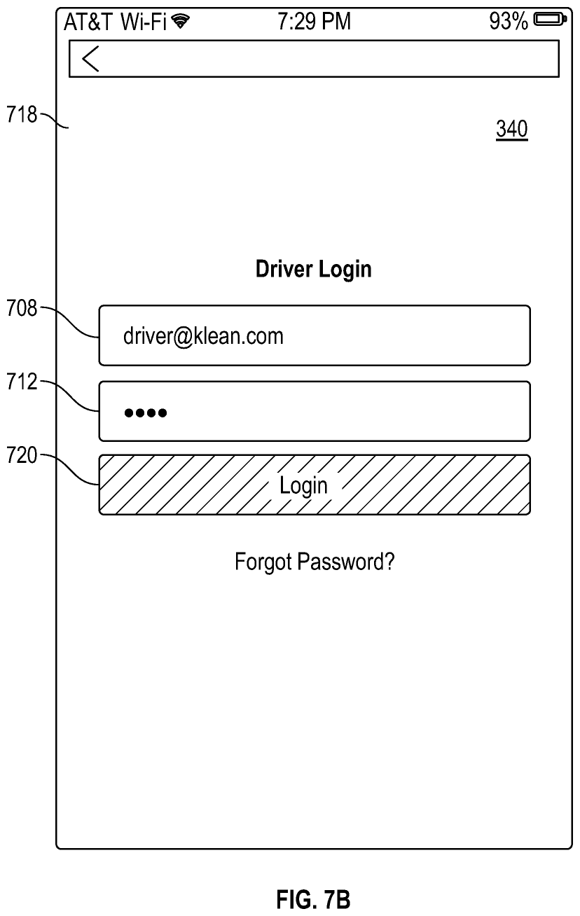

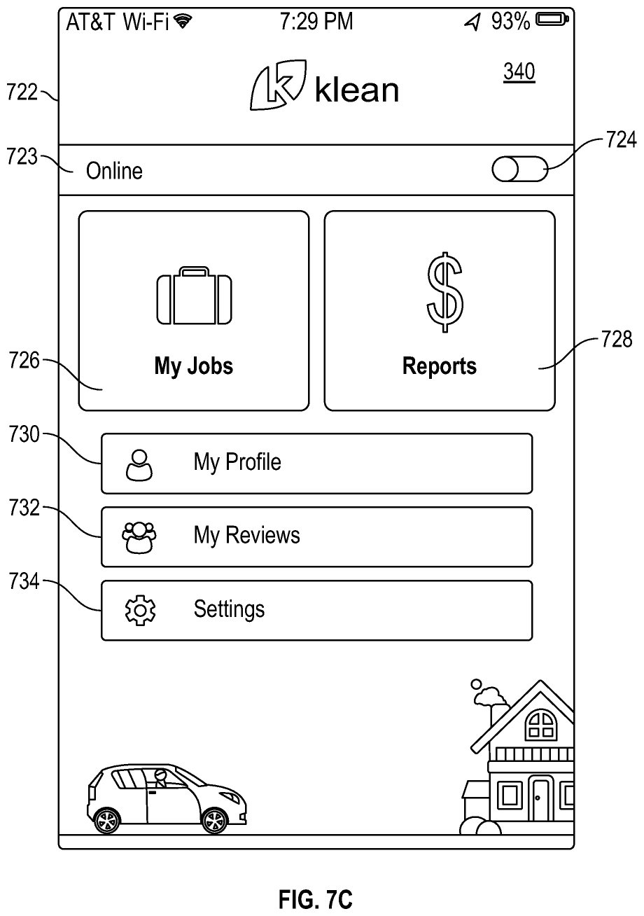

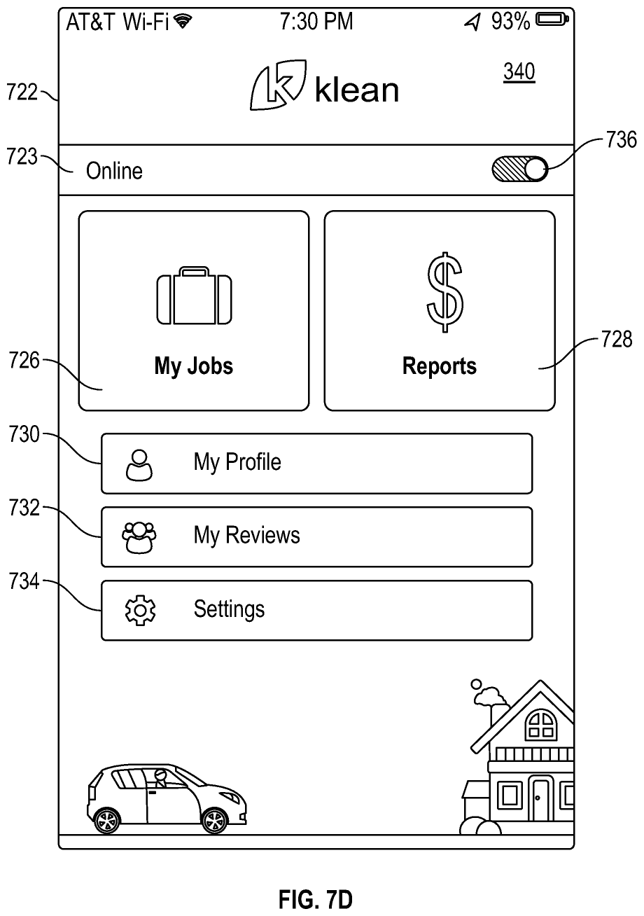

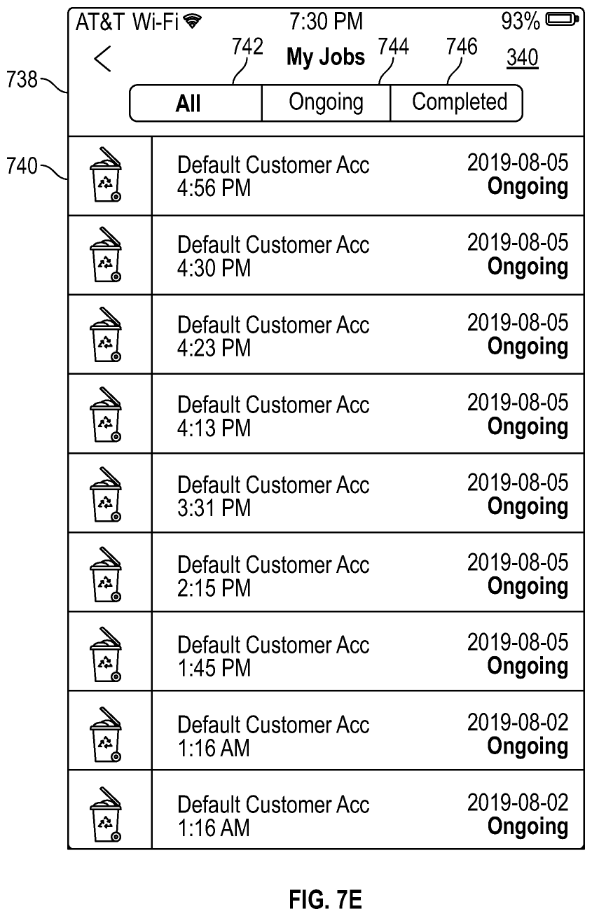

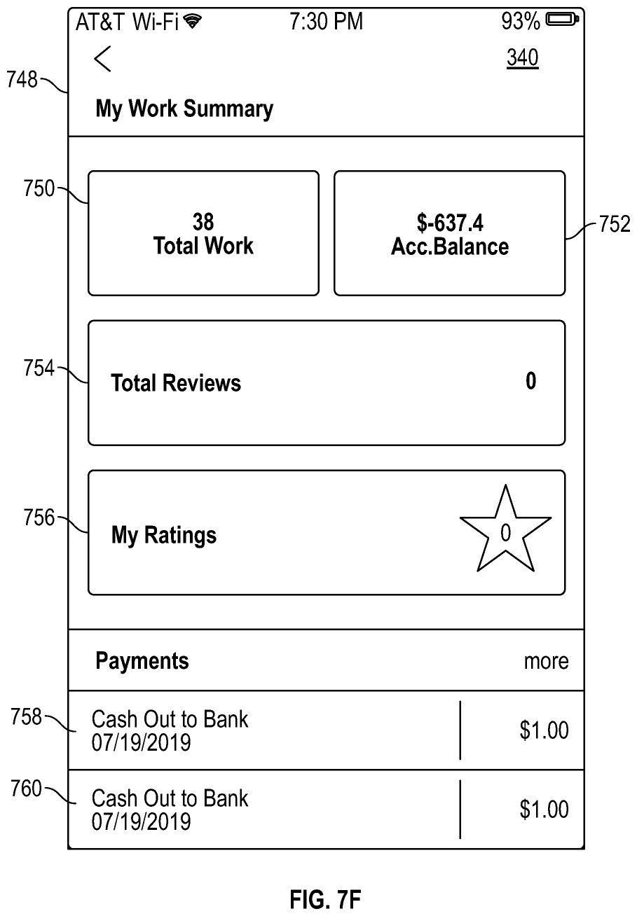

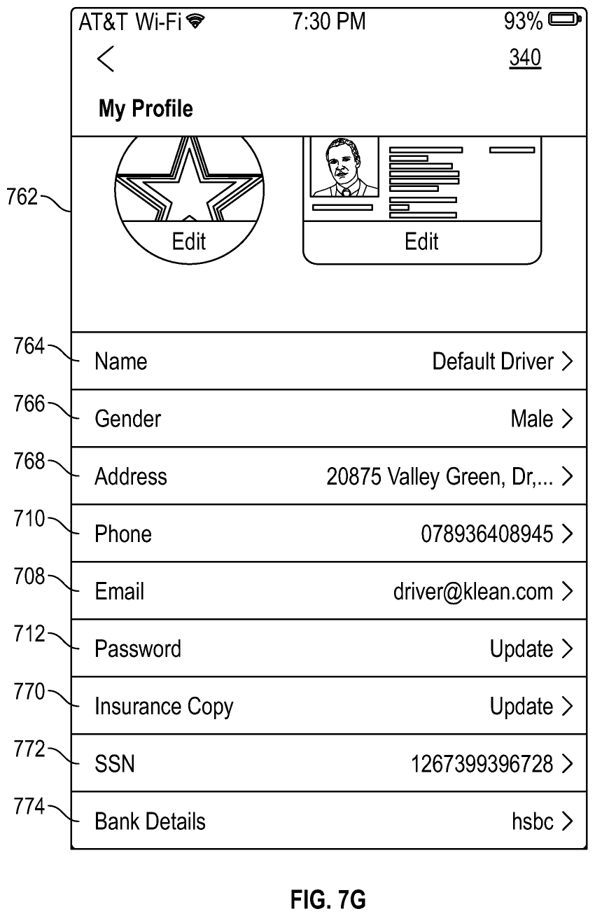

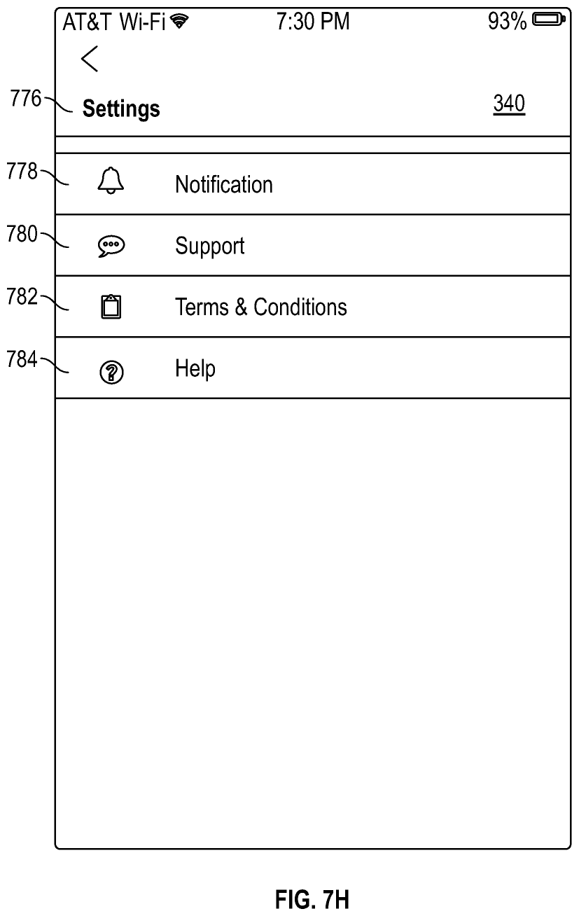

FIGS. 7A-7H together depict various illustrative screen shot views of an exemplary mobile device user interface presenting example driver operations.

In FIG. 7A, the exemplary mobile device user interface 340 is illustrated displaying an embodiment mobile app including the example Driver Sign Up screen 702. In the depicted example, the embodiment Driver Sign Up screen 702 includes fields for a user registering as a Driver to indicate their First Name 704, Last Name 706, Email Address 708, Phone Number 710, and Password 712. In some scenarios a registering driver may be requested to Confirm Password before tapping Sign Up 714 to complete registration. In the depicted embodiment, a Driver already registered with an account may tap Login 716 after providing their Email Address 708 and Password 712.

In FIG. 7B, the illustrative mobile device user interface 340 is depicted presenting an embodiment mobile app showing an illustrative registered Driver Login screen 718. In the illustrated embodiment a registered driver is shown providing their Email Address 708 and Password 712 before tapping Login 720 to access their account.

In FIG. 7C, the exemplary mobile device user interface 340 is illustrated displaying an embodiment mobile app including the example Driver home screen 722. In the depicted example, the embodiment Driver home screen 722 includes the Online status indicator 723 with the Online status control depicted in an exemplary Offline configuration 724. In the illustrated embodiment, the exemplary Driver home screen 722 provides a registered driver with access to job listings via My Jobs 726 to review work requests, and the Reports 728 option to access account financial records. In the depicted example, a registered driver may access their profile 730, study performance reviews 732, and edit settings 734.

In FIG. 7D, the illustrative mobile device user interface 340 is depicted displaying an embodiment mobile app including the example Driver home screen 722. In the illustrated example, the embodiment Driver home screen 722 includes the Online status indicator 723 with the Online status control depicted in an exemplary Online configuration 736. In the illustrated embodiment, the exemplary Driver home screen 722 provides a registered driver with access to job listings via My Jobs 726 to review work requests, and the Reports 728 option to access account financial records. In the illustrated example, a registered driver may access their profile 730, study performance reviews 732, and edit settings 734.

In FIG. 7E, the exemplary mobile device user interface 340 is illustrated displaying an embodiment mobile app including the example Driver My Jobs screen 738. In the illustrated example, the embodiment Driver My Jobs screen 738 includes the registered driver's job list 740 displayed with the customer account, date, time, and status of each job listed. In the depicted example, the registered driver may filter the jobs listing to show all 742, ongoing 744, or only completed 746 jobs.

In FIG. 7F, the illustrative mobile device user interface 340 is depicted presenting an embodiment mobile app including the exemplary Driver My Work Summary screen 748. In the depicted example, the embodiment Driver My Work Summary screen 748 includes the total jobs 750, account balance 752, Total Reviews 754, and My Ratings 756. The illustrated embodiment Driver My Work Summary screen 748 also provides Bank Payments information by transaction including Cash Out to Bank 758 and Cash Out to Bank 760 for their respective transactions.

In FIG. 7G, the exemplary mobile device user interface 340 is depicted displaying the illustrative Driver Profile screen 762 in an embodiment mobile app. In the illustrated embodiment, the exemplary Driver Profile screen 762 permits the registered driver to edit Account Profile data including Account Name 764, Gender 766, Home Address 768, Phone Number 710, Email Address 708, Password 712, Insurance Copy 770, SSN 772, and Bank Details 772.

In FIG. 7H, the exemplary mobile device user interface 340 is illustrated displaying the embodiment Driver Settings screen 776 in an exemplary mobile app. In the depicted embodiment, the exemplary Driver Settings screen 776 permits the registered driver to edit settings including Notification 778, in addition to providing access to Support 780, Terms & Conditions 782, and Help 784.

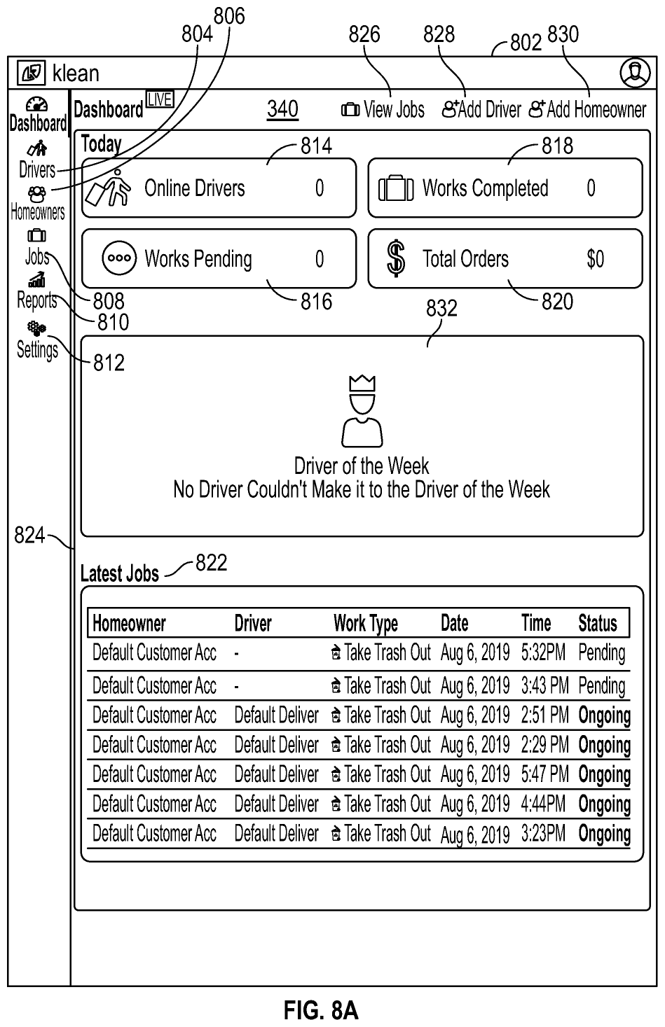

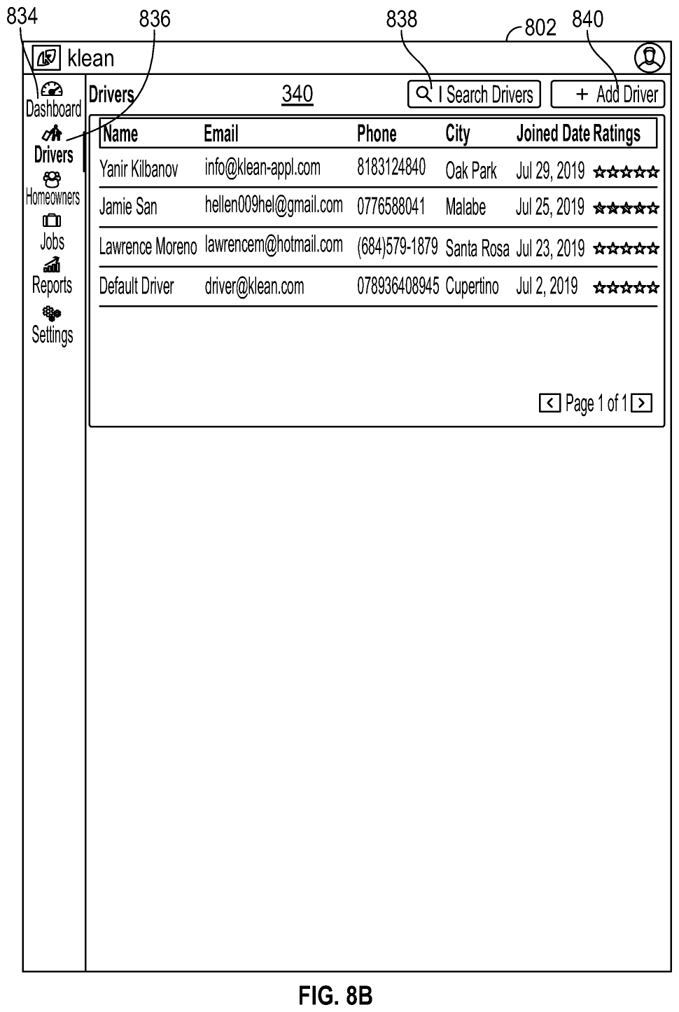

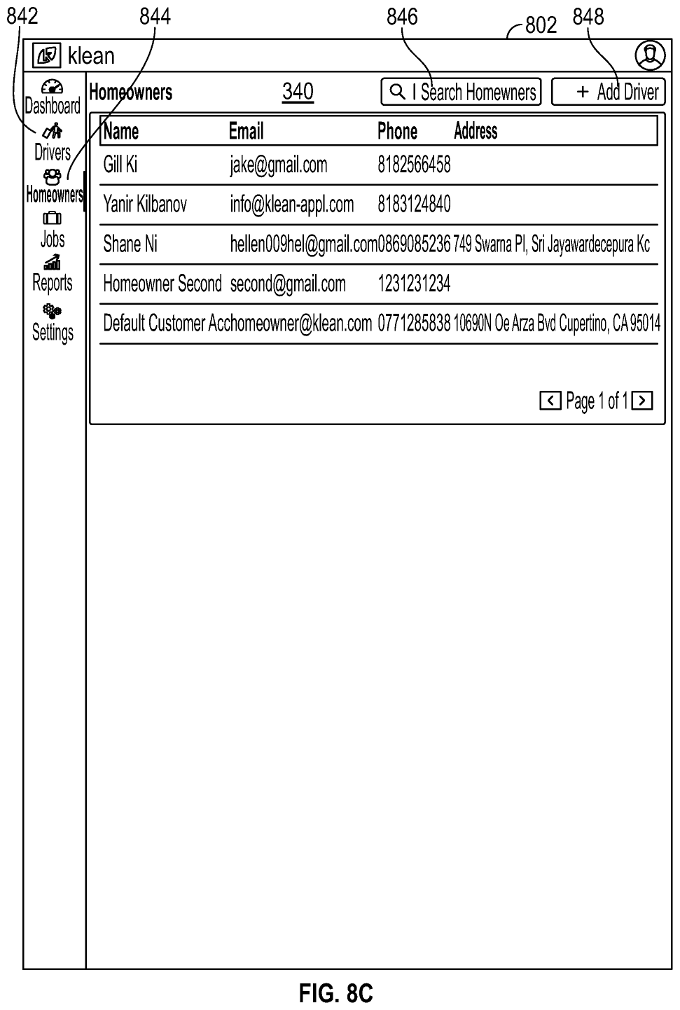

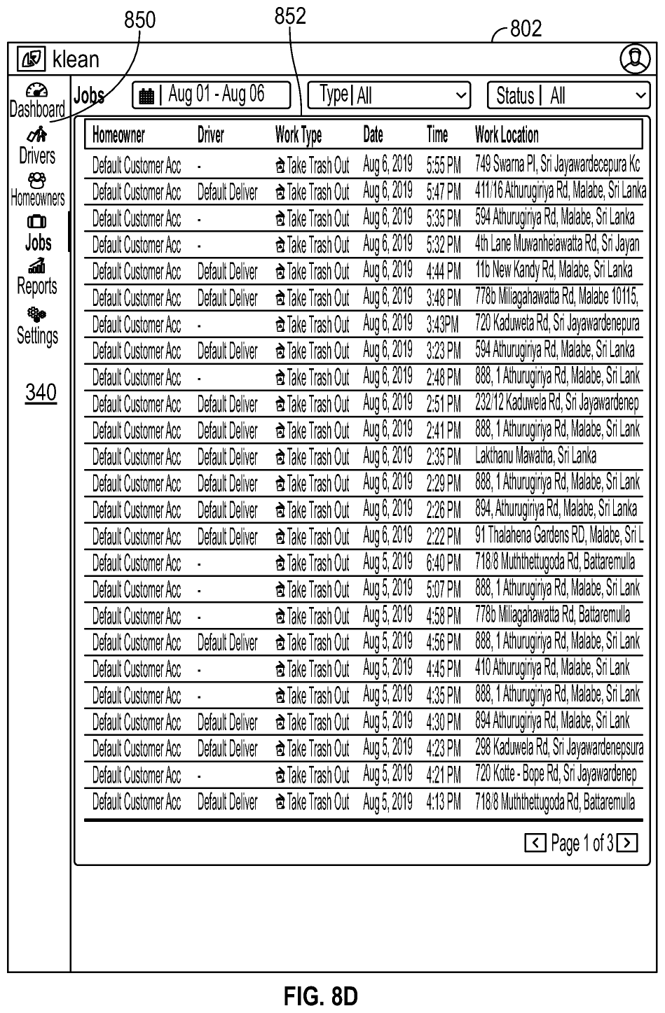

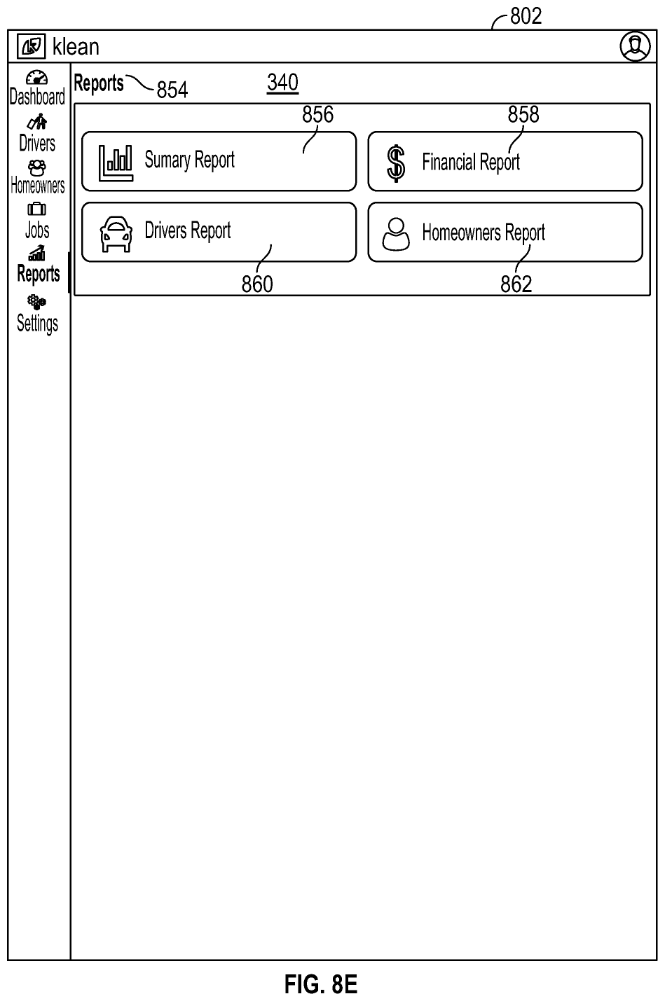

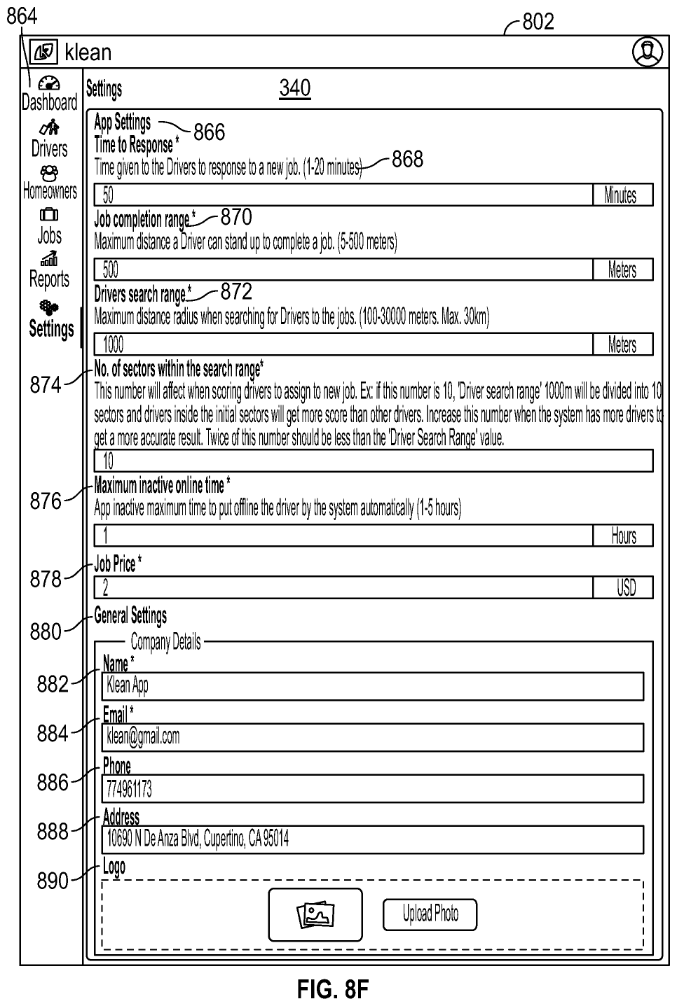

FIGS. 8A-8F together depict various illustrative screen shot views of an exemplary mobile device user interface presenting example administrative dashboard operations.

In FIG. 8A, the exemplary mobile device user interface 340 is depicted displaying the illustrative Live Dashboard screen 802 in an embodiment mobile app. In the illustrated embodiment, the exemplary Live Dashboard screen 802 permits the registered administrator to access status and manage drivers 804, homeowners 806, jobs 808, reports 810, and settings 812. In the depicted example, the Live Dashboard screen 802 includes summary status displays for Online Drivers 814, Work Pending 816, Work Completed 818, and Total Orders 820. The illustrated embodiment Live Dashboard screen 802 also includes the list of latest jobs 822 in the jobs status display 824. In the illustrated embodiment, the registered administrator may view jobs 826, add driver 828, add homeowner 830, or configure the driver of the week 832.

In FIG. 8B, the exemplary mobile device user interface 340 is illustrated presenting the illustrative Live Dashboard screen 802 Driver management portal 834 in an embodiment mobile app. In the illustrated embodiment, the exemplary Live Dashboard screen 802 Driver management portal 834 permits the registered administrator to access the registered drivers 836 including searching for drivers 838 and adding/deleting a driver 840. In the illustrated example the Driver management portal 834 permits the registered administrator to sort drivers by name, email address, phone number, city, and rating.

In FIG. 8C, the exemplary mobile device user interface 340 is depicted presenting the illustrative Live Dashboard screen 802 Homeowner management portal 842 in an embodiment mobile app. In the illustrated embodiment, the exemplary Live Dashboard screen 802 Homeowner management portal 842 permits the registered administrator to access the registered homeowners 844 including searching for homeowners 846 and adding/deleting a homeowner 848. In the illustrated example the Homeowner management portal 842 permits the registered administrator to sort homeowners by name, email address, phone number, and address.

In FIG. 8D, the exemplary mobile device user interface 340 is illustrated displaying the illustrative Live Dashboard screen 802 Jobs management portal 850 in an embodiment mobile app. In the illustrated embodiment, the exemplary Live Dashboard screen 802 Jobs management portal 850 permits the registered administrator to access the jobs 852 including searching for jobs by homeowner and driver, and filtering job listing by date, type, and status.

In FIG. 8E, the exemplary mobile device user interface 340 is depicted presenting the illustrative Live Dashboard screen 802 Reports portal 854 in an embodiment mobile app. In the depicted embodiment, the exemplary Live Dashboard screen 802 Reports portal 854 permits the registered administrator access to various reports including the Summary Report 856, Financial Report 858, Drivers Report 860, and Homeowners Report 862.

In FIG. 8F, the exemplary mobile device user interface 340 is illustrated displaying the illustrative Live Dashboard screen 802 Settings portal 864 in an embodiment mobile app. In the depicted embodiment, the exemplary Live Dashboard screen 802 Settings portal 864 permits the registered administrator to adjust various App Settings 866. In the depicted embodiment, the App Settings adjustable by the registered administrator include Time to Response 868, the time given to Drivers to respond to a new job, with a range of 1-20 minutes. In the illustrated embodiment, the registered administrator may also adjust Job Completion Range 870, the maximum distance a driver can stand up to complete a job, with a range of 5-500 meters. In the depicted embodiment, the registered administrator may also adjust the Driver Search Range 872, the maximum distance radius when searching for Drivers for the jobs, with a range of 100-30000 meters. In the illustrated embodiment, the registered administrator may also adjust the Number of sectors within the search range 874, which affects when scoring drivers to assign to a new job. For example, if this number is 10, a Driver search range 872 setting of 1000 m will be divided into 10 sectors and drivers inside the initial sectors will get more score than other drivers. In some examples, Number of sectors within the search range 874 may be increased when the system has more drivers, to obtain a more accurate result. In an illustrative example, twice the Number of sectors within the search range 874 should be less than the Driver Search Range 872 value. In the depicted embodiment, the registered administrator may also adjust the maximum inactive online time 876, the app inactive maximum time for the system to automatically put an inactive driver offline, with a range of 1-5 hours. In the depicted embodiment, the registered administrator may also adjust the Job Price 878. In the illustrated embodiment, the registered administrator may also adjust General Settings 880 including Company Name 882, Email Address 884, Phone Number 886, Address 888, and Logo 890. In the depicted example, the registered administrator may use the Upload Photo button to provide the Logo 890.

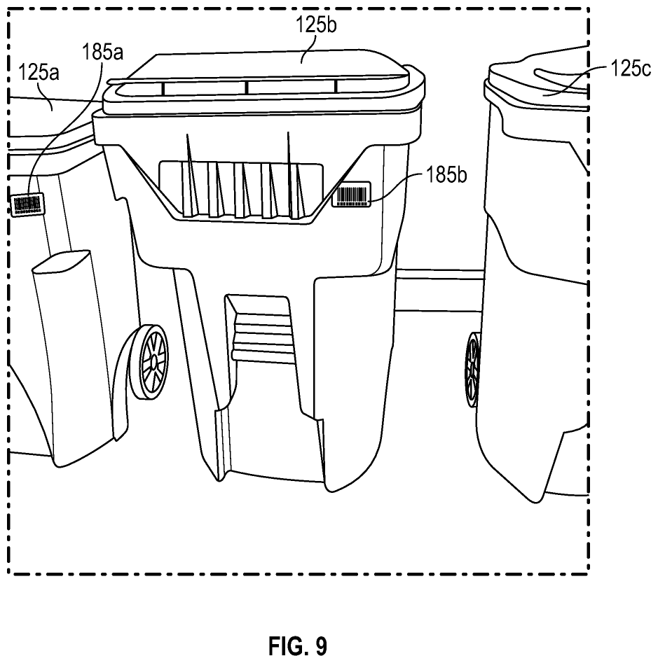

FIG. 9 depicts an illustrative view of exemplary waste receptacles configured with identifying encoded data. In the example depicted by FIG. 1, the waste receptacle 125a is configured with encoded data 185a to identify the waste receptacle 125a. In the illustrated example, the encoded data 185a includes optical code data. In the illustrated example, the waste receptacle 125b is configured with encoded data 185b identifying the waste receptacle 125b. In the depicted example, the waste receptacle 125c is not configured with identifying encoded data.

FIG. 10 depicts an illustrative process flow of an exemplary Location Based Work Coordination Engine (LBWCE) facilitating job assignment to a worker in accordance with various embodiments. The method depicted in FIG. 10 is given from the perspective of the Location Based Work Coordination Engine (LBWCE) 325 implemented via processor-executable program instructions executing on the driver mobile device 155 processor 305, described with reference to FIG. 3. In various embodiments, the method depicted in FIG. 10 may also be understood as from the perspective of the homeowner mobile device 110 implemented via processor-executable program instructions executing on the homeowner mobile device 110 processor 305, depicted in FIG. 3. In the illustrated embodiment, the LBWCE 325 executes as program instructions on the processor 305 configured in the LBWCE 325 host driver mobile device 155 or homeowner mobile device 110, described with reference to at least FIG. 1, FIG. 2, and FIG. 3. In some embodiments, the LBWCE 325 may execute as a cloud service communicatively and operatively coupled with system services, hardware resources, or software elements local to and/or external to the LBWCE 325 host homeowner mobile device 110 or driver mobile device 155. The depicted method 10000 begins at step 10005 with the processor 305 sending an electronic message comprising driver registration for trash receptacle transport. The method continues at step 10010 with the processor 305 sending an electronic message comprising driver location and available time for scheduling. The method continues at step 10015 with the processor 305 receiving a work request for a driver to transport a trash receptacle at a requested location and time. The method continues at step 10020 with the processor 305 presenting the work request to the driver to accept or decline. The method continues at step 10025 with the processor 305 performing a test to determine if the driver accepted the job. Upon a determination by the processor 305 at step 10025 the driver did not accept the job, the method continues at step 10010 with the processor 305 sending an electronic message comprising driver location and available time for scheduling. Upon a determination by the processor 305 at step 10025 the driver accepted the job, the method continues at step 10030 with the processor 305 sending an electronic message comprising an indication the driver accepted the work request. The method continues at step 10035 with the processor 305 presenting the driver with directions to the job beginning location received in an electronic message. The method continues at step 10040 with the processor 305 determining if the driver is within a predetermined minimum threshold distance from the job beginning location, and upon a determination the driver is within the predetermined minimum threshold distance from the job beginning location, sending an electronic message comprising an indication the driver is near the job beginning location to begin the work. The method continues at step 10045 with the processor 305 determining if the driver visited the beginning and ending locations and moved at least a predetermined minimum distance from the ending location, and upon a determination the driver visited the beginning and ending locations and moved at least the predetermined minimum distance from the ending location, presenting the driver with a button to indicate the job is complete. In various implementations, the method may repeat.

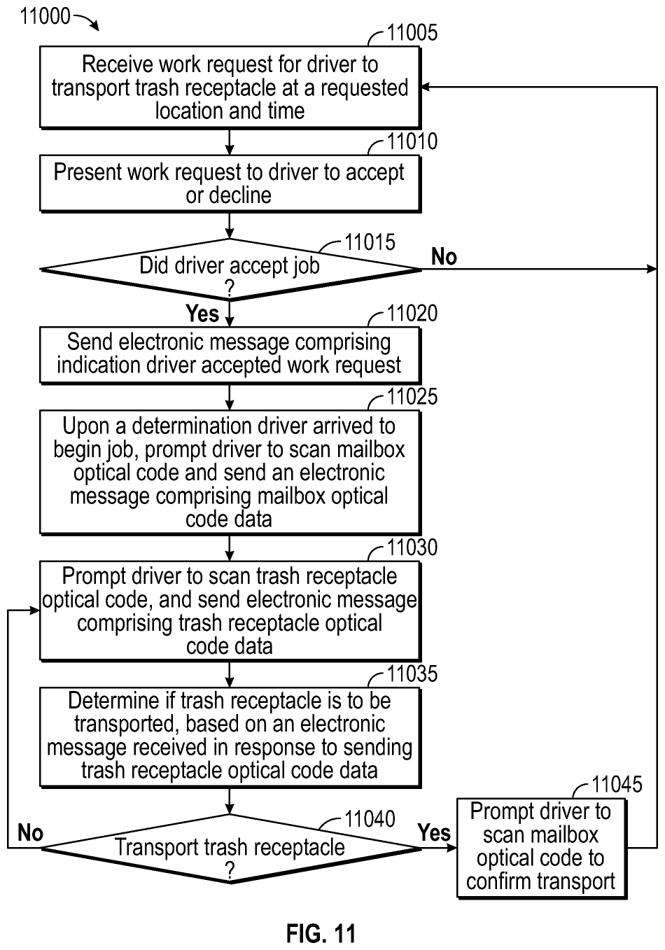

FIG. 11 depicts an illustrative process flow of an exemplary Location Based Work Coordination Engine (LBWCE) facilitating job assignment to a worker and associating data captured from a work item with data captured from job beginning and ending locations to confirm work completion, in accordance with various embodiments. The method depicted in FIG. 11 is given from the perspective of the Location Based Work Coordination Engine (LBWCE) 325 implemented via processor-executable program instructions executing on the driver mobile device 155 processor 305, described with reference to FIG. 3. In various embodiments, the method depicted in FIG. 11 may also be understood as from the perspective of the homeowner mobile device 110 implemented via processor-executable program instructions executing on the homeowner mobile device 110 processor 305, depicted in FIG. 3. In the illustrated embodiment, the LBWCE 325 executes as program instructions on the processor 305 configured in the LBWCE 325 host driver mobile device 155 or homeowner mobile device 110, described with reference to at least FIG. 1, FIG. 2, and FIG. 3. In some embodiments, the LBWCE 325 may execute as a cloud service communicatively and operatively coupled with system services, hardware resources, or software elements local to and/or external to the LBWCE 325 host homeowner mobile device 110 or driver mobile device 155. The depicted method 11000 begins at step 11005 with the processor 305 receiving a work request for a driver to transport a trash receptacle at a requested location and time. The method continues at step 11010 with the processor 305 presenting the work request to a driver to accept or decline. The method continues at step 11015 with the processor 305 performing a test to determine if the driver accepted the job. Upon a determination by the processor 305 at step 11015 the driver did not accept the job, the method continues at step 11005 with the processor 305 receiving a work request for a driver to transport a trash receptacle at a requested location and time. Upon a determination by the processor 305 at step 11015 the driver accepted the job, the method continues at step 11020 with the processor 305 sending an electronic message comprising an indication the driver accepted the job. The method continues at step 11025 with the processor 305 determining, based on location data, if the driver arrived to begin the job, and upon a determination the driver arrived to begin the job, prompt the driver to scan a mailbox optical code, and send an electronic message comprising the mailbox optical code data. The method continues at step 11030 with the processor 305 prompting the driver to scan the trash receptacle optical code, and send an electronic message comprising the trash receptacle optical code data. The method continues at step 11035 with the processor 305 determining the transport status of the trash receptacle, based on an electronic message received in response to sending the trash receptacle optical code data. The method continues at step 11040 with the processor 305 performing a test to determine if the trash receptacle is to be transported, based on the transport status determined by the processor 305 at step 11035. Upon a determination by the processor 305 at step 11040 the trash receptacle is not to be transported, the method continues at step 11030 with the processor 305 prompting the driver to scan the trash receptacle optical code, and send an electronic message comprising the trash receptacle optical code data. Upon a determination by the processor 305 at step 11040 the trash receptacle is to be transported, the method continues at step 11045 with the processor 305 prompting the driver to scan the mailbox optical code to confirm transport, and the method continues at step 11005 with the processor 305 receiving a work request for a driver to transport a trash receptacle at a requested location and time. In various embodiments, the method may repeat.

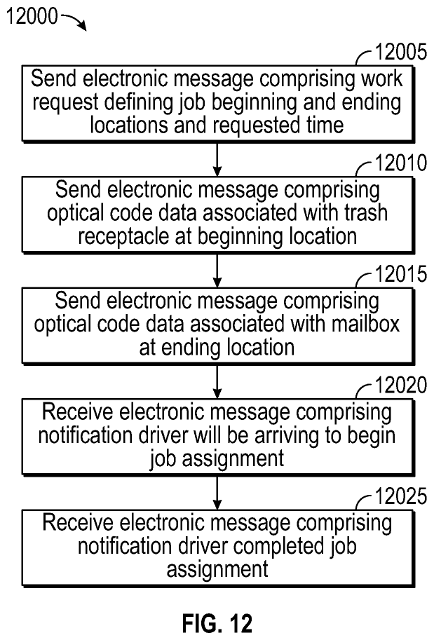

FIG. 12 depicts an illustrative process flow of an exemplary Location Based Work Coordination Engine (LBWCE) facilitating a homeowner work request in accordance with various embodiments. The method depicted in FIG. 12 is given from the perspective of the Location Based Work Coordination Engine (LBWCE) 325 implemented via processor-executable program instructions executing on the homeowner mobile device 110 processor 305, described with reference to FIG. 3. In various embodiments, the method depicted in FIG. 12 may also be understood as from the perspective of the driver mobile device 155 implemented via processor-executable program instructions executing on the driver mobile device 155 processor 305, described with reference to FIG. 3. In the illustrated embodiment, the LBWCE 325 executes as program instructions on the processor 305 configured in the LBWCE 325 host driver mobile device 155 or homeowner mobile device 110, described with reference to at least FIG. 1, FIG. 2, and FIG. 3. In some embodiments, the LBWCE 325 may execute as a cloud service communicatively and operatively coupled with system services, hardware resources, or software elements local to and/or external to the LBWCE 325 host homeowner mobile device 110 or driver mobile device 155. The depicted method 12000 begins at step 12005 with the processor 305 sending an electronic message comprising a work request defining job beginning and job ending locations and a requested time. The method continues at step 12010 with the processor 305 sending an electronic message comprising optical code data associated with a trash receptacle at the job beginning location. The method continues at step 12015 with the processor 305 sending an electronic message comprising optical code data associated with a mailbox at the job ending location. The method continues at step 12020 with the processor 305 receiving an electronic message comprising a notification the driver will be arriving to begin the job assignment. The method continues at step 12025 with the processor 305 receiving an electronic message comprising a notification the driver completed the job assignment. In some examples, the processor 305 may associate the notification the driver will be arriving, received at step 12020, with the notification the driver completed the job, received at step 12025, to confirm the job was completed, and send an electronic message comprising an authorization to pay for the job, based on the confirmation. In various embodiments, the method may repeat.

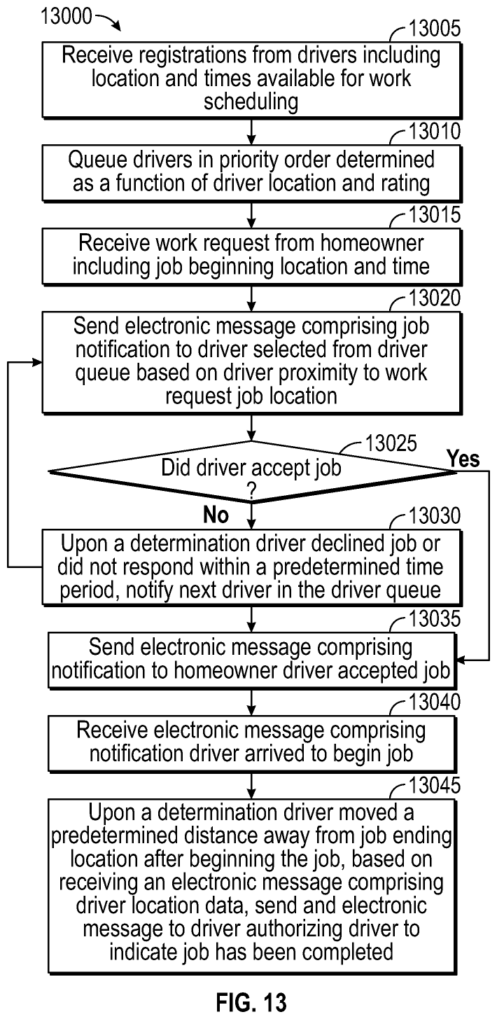

FIG. 13 depicts an illustrative process flow of an exemplary Location Based Work Assignment Engine (LBWAE) facilitating finding a worker to complete a job assignment in accordance with various embodiments. The method depicted in FIG. 13 is given from the perspective of the Location Based Work Assignment Engine (LBWAE) 425 implemented via processor-executable program instructions executing on the work assignment server 120 processor 405, depicted in FIG. 4. In the illustrated embodiment, the LBWAE 425 executes as program instructions on the processor 405 configured in the LBWAE 425 host work assignment server 120, depicted in at least FIG. 1, FIG. 2, and FIG. 4. In some embodiments, the LBWAE 425 may execute as a cloud service communicatively and operatively coupled with system services, hardware resources, or software elements local to and/or external to the LBWAE 425 host work assignment server 120. The depicted method 13000 begins at step 13005 with the processor 405 receiving registrations from drivers including locations and times available for work scheduling. The method continues at step 13010 with the processor 405 queueing drivers in priority order determined as a function of driver location and rating. The method continues at step 13015 with the processor 405 receiving a work request from a homeowner including a job beginning location and time. The method continues at step 13020 with the processor 405 sending an electronic message comprising a job notification to a driver selected from the driver queue based on driver proximity to the work request job location. The method continues at step 13025 with the processor 405 performing a test to determine if the driver accepted the job. Upon a determination by the processor 405 at step 13025 the driver did not accept the job, the method continues at step 13030 with the processor 405 determining if the driver declined the job or did not respond within a predetermined time period, and upon a determination the driver declined the job or did not respond within the predetermined time period, the method continues at step 13020 with the processor 405 notifying the next driver in the driver queue based on sending an electronic message comprising a job notification to a driver selected from the driver queue based on driver proximity to the work request job location. Upon a determination by the processor 405 at step 13025 the driver accepted the job, the method continues at step 13035 with the processor 405 sending an electronic message comprising notification to the homeowner the driver accepted the job. The method continues at step 13040 with the processor 405 receiving an electronic message comprising notification the driver arrived to begin the job. The method continues at step 13045 with the processor 405 determining if the driver moved a predetermined distance away from the job ending location after beginning the job based on receiving an electronic message comprising driver location data, and upon a determination the driver moved a predetermined distance away from the job ending location after beginning the job based on receiving an electronic message comprising driver location data, sending an electronic message to the driver authorizing the driver to indicate the job was completed. In various embodiments, the method may repeat.

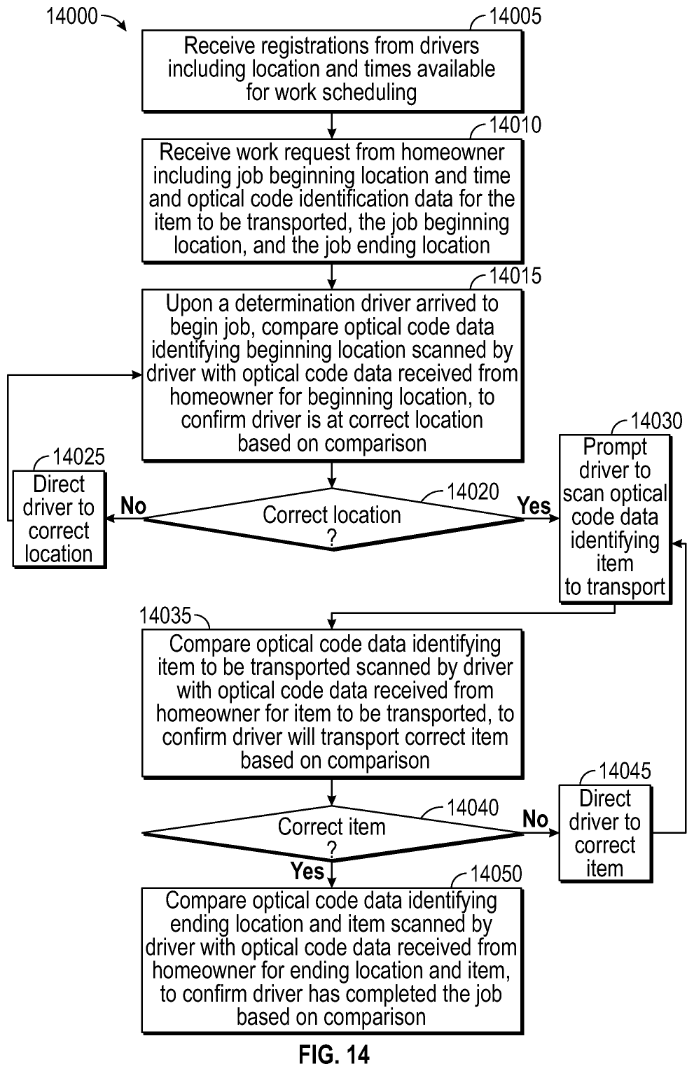

FIG. 14 depicts an illustrative process flow of an exemplary Location Based Work Assignment Engine (LBWAE) facilitating finding a worker to complete a job assignment and associating data captured from a work item with data captured from job beginning and ending locations to confirm work completion, in accordance with various embodiments. The method depicted in FIG. 14 is given from the perspective of the Location Based Work Assignment Engine (LBWAE) 425 implemented via processor-executable program instructions executing on the work assignment server 120 processor 405, depicted in FIG. 4. In the illustrated embodiment, the LBWAE 425 executes as program instructions on the processor 405 configured in the LBWAE 425 host work assignment server 120, depicted in at least FIG. 1, FIG. 2, and FIG. 4. In some embodiments, the LBWAE 425 may execute as a cloud service communicatively and operatively coupled with system services, hardware resources, or software elements local to and/or external to the LBWAE 425 host work assignment server 120. The depicted method 14000 begins at step 14005 with the processor 405 receiving registrations from drivers including locations and times available for work scheduling. The method continues at step 14010 with the processor 405 receiving a work request from a homeowner including a job beginning location and time and optical code identification data for the item to be transported, the job beginning location, and the job ending location. The method continues at step 14015 with the processor 405 determining if the driver arrived to begin the job, based on location data, and upon a determination the driver arrived to begin the job, comparing the optical code data identifying the beginning location scanned by the driver with optical code data received from the homeowner for the beginning location, to confirm the driver is at the correct location based on the comparison. The method continues at step 14020 with the processor 405 performing a test to determine if the driver is at the correct location, based on the comparison performed by the processor 405 at step 14015. Upon a determination by the processor 405 at step 14020 the driver is not at the correct location, the method continues at step 14025 with the processor 405 directing the driver to the correct location, and the method continues at step 14015 with the processor 405 determining if the driver arrived to begin the job, based on location data, and upon a determination the driver arrived to begin the job, comparing the optical code data identifying the beginning location scanned by the driver with optical code data received from the homeowner for the beginning location, to confirm the driver is at the correct location based on the comparison. Upon a determination by the processor at step 14025 the driver is in the correct location, the method continues at step 14030 with the processor 405 prompting the driver to scan optical code data identifying the item to transport, and the method continues at step 14035 with the processor 405 comparing optical code data identifying the item to be transported scanned by the driver with optical code data received from the homeowner for the item to be transported, to confirm the driver will transport the correct item based on the comparison. The method continues at step 14040 with the processor 405 performing a test to determine if the driver has located the correct item to transport, based on the comparison performed by the processor 405 at step 14035. Upon a determination by the processor 405 at step 14040 the driver has not located the correct item to transport, the method continues at step 14045 with the processor 405 directing the driver to the correct item, and the method continues at step 14030 with the processor 405 prompting the driver to scan optical code data identifying the item to transport. Upon a determination by the processor 405 at step 14040 the driver has located the correct item to transport, the method continues at step 14050 with the processor 405 comparing optical code data identifying the job ending location and the item scanned by the driver with optical code data received from the homeowner for the ending location and item, to confirm the driver has completed the job based on the comparison. In various embodiments, the method may repeat.

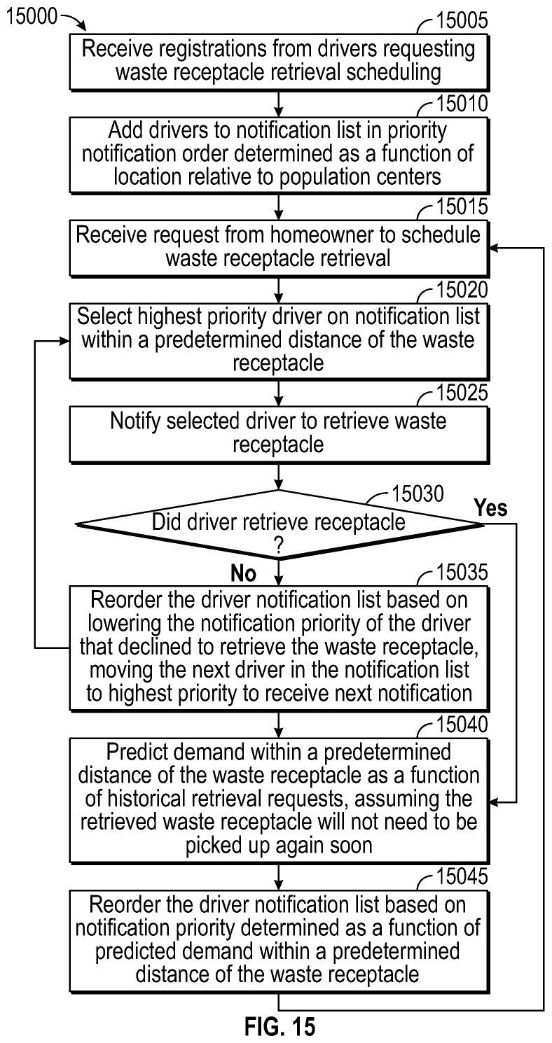

FIG. 15 depicts an illustrative process flow of an exemplary Location Based Work Assignment Engine (LBWAE) facilitating finding a worker to complete a job assignment and reordering potential worker notification priority based on worker proximity to predicted demand, in accordance with various embodiments. The method depicted in FIG. 15 is given from the perspective of the Location Based Work Assignment Engine (LBWAE) 425 implemented via processor-executable program instructions executing on the work assignment server 120 processor 405, depicted in FIG. 4. In the illustrated embodiment, the LBWAE 425 executes as program instructions on the processor 405 configured in the LBWAE 425 host work assignment server 120, depicted in at least FIG. 1, FIG. 2, and FIG. 4. In some embodiments, the LBWAE 425 may execute as a cloud service communicatively and operatively coupled with system services, hardware resources, or software elements local to and/or external to the LBWAE 425 host work assignment server 120. The depicted method 15000 begins at step 15005 with the processor 405 receiving registrations from drivers requesting waste receptacle retrieval scheduling. The method continues at step 15010 with the processor 405 adding drivers to a notification list in priority notification order determined as a function of location relative to population centers. The method continues at step 15015 with the processor 405 receiving a request from a homeowner to schedule waste receptacle retrieval. The method continues at step 15020 with the processor 405 selecting the highest priority driver on the notification list within a predetermined distance of the waste receptacle. The method continues at step 15025 with the processor 405 notifying the selected driver to retrieve the waste receptacle. The method continues at step 15030 with the processor 405 performing a test to determine if the driver retrieved the waste receptacle. Upon a determination by the processor 405 at step 15030 the driver did not retrieve the waste receptacle, the method continues at step 15035 with the processor 405 reordering the driver notification list based on lowering the notification priority of the driver that declined to retrieve the waste receptacle, moving the next driver in the notification list to highest priority to receive the next notification, and the method continues at step 15020 with the processor 405 selecting the highest priority driver on the notification list within a predetermined distance of the waste receptacle. Upon a determination by the processor 405 at step 15030 the driver retrieved the waste receptacle, the method continues at step 15040 with the processor 405 predicting demand within a predetermined distance of the waste receptacle as a function of historical retrieval requests, assuming the retrieved waste receptacle will not need to be picked up again soon. In various embodiments, the predicted demand may be recalculated as waste receptacles are retrieved, based on determining the probability waste receptacles that have not been picked up for some time may be the subject of a pickup request in the near term, for example, in the next two hours. In an illustrative example, the probability a specific trash receptacle may need to be transported in the near term may be recalculated in real time as nearby trash receptacles are transported in alignment with municipal collection schedules and historical work request data. In some examples, drivers may be notified with suggestions to temporarily position themselves in areas expected to experience higher than average predicted near-term demand, advantageously encouraging drivers to relocate toward areas with higher anticipated demand. The method continues at step 15045 with the processor 405 reordering the driver notification list based on notification priority determined as a function of predicted demand within a predetermined distance of the waste receptacle, and the method continues at step 15015 with the processor 405 receiving a request from a homeowner to schedule waste receptacle retrieval.

Although various embodiments have been described with reference to the Figures, other embodiments are possible. For example, various implementations may include an app that makes it possible for homeowners across the United States to take out their trash cans using their mobile phones. In an illustrative example, an embodiment app nay be very simple and user friendly, permitting a homeowner to select the time window within the hour to have their trash cans either taken outside from their private property to the front curb, or vice versa. Some embodiments may include a one-time service that may only be used to schedule one service at a time. In various one-service-at-a-time implementations, a homeowner would have to call to have their trash cans brought in the following day if they choose to use that service, or vice versa, meaning they can take out their trash can and can have it arranged to be brought back in. In an illustrative example, some app embodiments may include a subscription based option, permitting a home owner to sign up for a monthly rate to have their trash cans taken out and brought back to their property.

In some examples, as a homeowner sends a request, that request goes to registered drivers, one driver at a time. For example, only one driver may receive this request at a time, with an algorithm based on both proximity and the stars the driver has been rewarded. That driver then has a predetermined time, for example, 5 minutes, to accept this job. If the driver does not accept the job within the predetermined time or declines the job, the request goes to the next available driver based on the same algorithm. In an illustrative example, this may continue up until the 30 minute mark in between the 1 hour time window when the home owner requested to have their trash taken out. In some designs, once the time reaches an in between, 30 minute mark, the homeowner will receive a notification that there are not enough available drivers in that area. In various embodiments, a driver may accept multiple jobs (for example, 5 or more) so that the driver may establish a pipe line of jobs to do. In some implementations, once the driver completes a job, the driver may then mark the button “job completed,” which will only appear once the driver is a certain proximity away from the specific job that the driver is on.

Some embodiment implementations may incorporate encoded data, for example, an optical code such as a QR code, or barcode, attached to a trash can or mailbox, to identify the trash can or mailbox. In an illustrative example, encoded data useful for the purpose disclosed to identify a trash receptacle, or job beginning or job ending locations, may include encoded data accessible via optical code, RFID®, or NFC®, affixed to the job beginning or job ending location, or attached to a work item, such as, for example, an object to be transported. Various types of encoded data may provide one or more advantage. For example, encoded data accessible via optical code may provide a unique identifier that may be re-assigned to another account or customer via a database update associating a different customer account with the identifier, without a physical change to the identifier. In some examples, encoded data accessible via an RFID® tag may be read without contact to an object retaining the data. In various scenarios, RFID® tag data may be accessible in low light conditions or in dirty conditions when optical code data may be obscured. In an illustrative example, encoded data accessible via an NFC® tag may be modifiable to record status in the object to be transported, in addition to providing access to identifying data without contact to the object to be transported. In some examples, useful identifying encoded data may be pre-existing in the job beginning or job ending location, such as, for example, an existing optical code configured in a utility marker or utility pole. In such an example, existing encoded data such as a utility pole optical code may be scanned by a driver or homeowner and associated to the job beginning or job ending location to permit tracking trash receptacle transport and confirm job completion. In an illustrative example, optical code attached to a trash can or mailbox will allow tracking the exact trash can movement in the future, and how many trash cans have been taken out to the street or brought back to the property, to follow the movement of that specific trash can for that day, week, month, or year. In an illustrative example, a mailbox barcode will permit following that specific house directly. For example, once the driver has finished logging in a trash can barcode, the driver can check off the mail box barcode to mark the home as complete, or incomplete. This will allow tracing whether the work for each trash can of the house, and the house as a whole, has been completed.

In an illustrative example, when a home owner/client/management person wants to take their trash cans/bins/containers outside from a predesignated location on their private/commercial property they may use the app and scheduling service. In some exemplary scenarios, an embodiment app and scheduling service may match them to a driver who is online in their area using an algorithm based chiefly on location and rating from previous jobs the driver completed.

In some embodiments, once a driver receives the job details, the driver has the option to accept or decline the job based on the specifications (location/time). In an illustrative example, if the driver accepts the job, a match has been made between the client and driver, and the work is assigned to the driver. In some implementations, the driver may receive directions via an online map service to their house/job location and may perform the task of relocating the garbage cans from the homeowner's private property to the designated trash pickup location based on specific direction the client/homeowner provided in their directions setting before requesting the job. Some example designs may include an instructions field, permitting a homeowner to provide gate codes, how many trash cans to take out, and the like. In some embodiments, the driver may accumulate multiple trash pickup jobs from multiple homeowners as they become available in the driver's area, and accept or decline the jobs, building a pipeline of jobs.

In an illustrative example, once a driver arrives at a property where a task is to be done, the driver may “check in” using the mail box optical code, to let the system know that the driver has begun the job. In some embodiments, this may also let the homeowner know that a driver has arrived at the private property, for example, via instant notification message using any of a variety of messaging or communication services, as soon as the driver scans the mail box optical code. This may help keep the client/homeowner calm, by letting them know a registered driver is on the homeowner's property, relieving the homeowner that the stranger on their property is actually a driver who will complete the requested by the homeowner.

In some embodiments, a driver may scan each individual trash can before he moves/relocates the trash can, so that the system knows exactly which trash can is being moved. In an illustrative example, this will permit tracking each trash can's movement from before and after the relocation/positioning of the trash can, from the private property to the public street. In some scenarios, this may also enable tracking, or identifying, the trash cans based on the homeowner's instruction. For example, if the homeowner wants to take out only 3 out of 5 trash cans, the homeowner may have the option to also scan only the trash cans they want taken out. In various embodiments, once the driver brings that trash can out to the public street, the driver may scan the trash can again to mark that it is at its relocated position and ready for pick up. In an illustrative example, an embodiment system may mark that trash can as completed/flagged in the trash can location. In some scenarios, a driver may mark a trash can as completed/flagged for the remainder of the individual trash cans, which will cover the same process. For example, a driver may then scan the mailbox when the driver is finished with the trash cans, which will mark the job as complete, at which point the client may receive another notification that the homeowner's tasks have been completed.

In some embodiments, the homeowner may take a picture of where they want their trash cans to be brought back to within their property from the public street or collection location. In some scenarios, such image-based identification of the trash receptacle return location may work better than written instructions, or at least provide a useful supplement to written instructions. In an illustrative example, a driver following such a visual guide to return a homeowner's trash cans would know exactly where to bring the trash cans from the public street, and exactly where to place them on private property, based on a picture in a visual guide. Likewise, in some embodiments, a driver may upload a picture back onto the system when the driver has completed their work, to show that the trash cans are in the same place as the homeowner's request, per the picture, to help confirm that the job has been completed.

In various embodiments, completed jobs may be marked by proximity to the job location (for example: within a 25 ft radius the app may allow a driver to click “complete” because they are in the proximity of the job site). In some embodiments, once the driver accepts a job, the home owner will get a notification that someone is on the way to do the service. In some exemplary scenarios, once a driver marks a job as complete, the home owner may be sent a notification that the job has been completed.

In various implementations, an embodiment location based work assignment design may include a Hybrid Mobile (IOS® and ANDROID®) application configured with General Admin Functions, Reporting, and a Live Dashboard. Some embodiment implementations may be referred to as Klean™.

In some embodiments, various application designs may be implemented using various technologies. In an illustrative example, some embodiment functions may be split across a Web Application and Mobile Application. Some Web Application embodiment designs may run on the Linux® Operating System backed by MySQL® storage access implemented with programming language and supporting frameworks including PHP®, Angular JS, Angular Bootstrap, JQUERY®, HTML 5, CSS®, and JS® (JAVASCRIPT®). Various embodiment web application designs may be provided via AWS® by an APACHE® Web Server hosted in an AMAZON® CLOUD® production environment. Some mobile application embodiments may be implemented across multiple platforms, for example IOS® and ANDROID®, using programming languages including JAVASCRIPT®, SWIFT®, JAVA®, and OBJECTIVE-C®, with supporting frameworks such as React Native.

General Admin

In an illustrative example, various embodiments' General Admin functions may include Adding/Editing/Viewing records and configuration for registered “Drivers” and “HomeOwners.” In some examples, an Admin may be permitted to deactivate a driver account when required. Various embodiment designs may allow an Admin to update company details, including, for example Phone, email, account name, address, financial account details, and the like.

Reporting

In some implementation examples, the Reporting features may include viewing the income of workers, the total number of workers, the total number of customers, and revenue from customers. Some designs may include the capability to manually manage cash outs for workers. Exemplary reporting features in some embodiments may include viewing total revenue for a provided period of time.

Live Dashboard

Various Live Dashboard implementation features may include viewing the total number of active workers and customers, including the total pending jobs, and available (Online) Drivers. Hybrid Mobile Application (IOS® and ANDROID®)

In an illustrative example, various location based work assignment embodiment implementations may include one or more of a Driver, HomeOwner, or Find a Worker process. In various scenarios, one or more of the Driver, HomeOwner, or Find a Worker processes may be implemented in a mobile device, server, tablet, smartphone, or other user-operable device. In some embodiments, one or more of the Driver, HomeOwner, or Find a Worker processes may be combined into a single process. In various embodiments, one or more of the Driver, HomeOwner, or Find a Worker processes may be combined into fewer than three processes. In some embodiment implementations, one or more of the Driver, HomeOwner, or Find a Worker processes may be implemented as an autonomous agent operable without human user intervention.

Driver

In an example illustrative of various implementations, an embodiment Driver process may be configured to permit available drivers to Register on the app with an account configured to enable the driver to login to the app and edit the driver profile details after Accepting Terms & Conditions. In various designs, the driver profile details configurable by a driver may include Name, Gender, Address, Phone, Email Address, Password, Insurance Copy, SSN, and Bank Details. Various Driver process implementations may permit a registered driver to access historical account and performance records, including to View their reviews, and View Ongoing/Past Jobs. Some illustrative Driver process user interface examples may permit registered drivers to Receive Jobs, View Reports, and Update Settings, including setting availability times and locations to receive job notifications. For example, a registered driver may Change Online/Offline Status, and enable or disable the capability to Receive Push Notifications within a radius of selected job notifications.

Driver Process

In an illustrative example, a user may register in the system as a “Driver” by filling a registration form. In various embodiments, once a registered Driver opens the app, the driver may update their location and settings in the profile. In some implementations, drivers may be notified about nearby jobs via app notifications. In various designs, drivers may be permitted a period of time, for example, 5 minutes, to accept a job request. In some examples, if the notified driver does not approve the job within the time period, such as 5 minutes in this example, the job notification may be sent to the next most relevant driver. In an illustrative example the driver may be provided directions to the HomeOwner' s location from an online map provider. In some designs, once the worker completes the task, the task can be marked as completed by the driver using a “Task complete” button, which will be enabled only within a predetermined radius (for example 100 ft, can be changed by an admin) from the work location. In various designs, a virtual bank account may be maintained inside the system for drivers, and an admin may manually pay drivers, and update the system with the cash outs.

HomeOwner

In an illustrative example, a HomeOwner may complete Registration to submit work requests to be completed by available drivers. In addition to submitting a work request, a registered HomeOwner may Login to Add/Edit Profile details including Name, Gender, Home Address, Phone, Email Address, Password, Credit Card Details, and Insurance Copy. In various embodiments, a registered HomeOwner may Add and/or edit reviews for workers, and Post Trashln/TrashOut Jobs to the system. In some examples, a HomeOwner may be permitted to View Pending & Previous Jobs and Update Settings including setting their availability to Receive Push Notifications

HomeOwner Process

In an example illustrative of various HomeOwner Process embodiment implementations, a HomeOwner may fill in a registration form in to register in the system. In various designs, a HomeOwner may update their profile, including payment details & other information from the Profile section. After registering, a HomeOwner may post a work request, including a job to be completed by an available worker. In an illustrative example, a HomeOwner may post two types of Jobs: Put trash out, and Put trash in. In various designs, once the HomeOwner selects an option, the HomeOwner may provide location, time/date and instructions for the driver. In some embodiments, once the HomeOwner enters the parameters of the job, the HomeOwner/customer may confirm the job by clicking on the “Accept & Confirm” button. In an illustrative example, once the customer clicks on “Confirm”, the system will automatically assign the job to the nearest driver with the best rating. In some examples, once an available driver accepts the job, then the HomeOwner may be sent a “work accepted” notification, or “Cancelation” notification, if no one Accepted. In various embodiments, once the assigned driver finishes the job, the HomeOwner may be sent a “work completed” notification, and the HomeOwner is charged for payment once the work is completed and marked as completed. In an illustrative example, after the work has been verified as completed, the HomeOwner may provide a star rating, and add a review about the Job or Jobs completed by the driver.

Find a Worker Process

In an illustrative example, once a job is placed by HomeOwner, the system will assign the job to a driver. In various embodiments, the system may select a driver by considering details such as, for example: Location (80%)-the system will select Drivers nearby to the work location; and, Reviews (20%)-the system will consider the star rating of the available worker. In some implementations, once a Driver is selected by the system, the HomeOwner will be notified through an app notification. In various examples, a Driver may be permitted a predetermined time, for example, 5 minutes, to accept each job. In an illustrative example, if a Driver does not respond to the job within the predetermined time, 5 minutes in this example, then the Job is sent to the next available Driver.

In the Summary above and in this Detailed Description, and the Claims below, and in the accompanying drawings, reference is made to particular features of various embodiments of the invention. It is to be understood that the disclosure of embodiments of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In various embodiments. elements described herein as coupled or connected may have an effectual relationship realizable by a direct connection or indirectly with one or more other intervening elements.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting.

In the present disclosure, all embodiments where “comprising” is used may have as alternatives “consisting essentially of,” or “consisting of.” In the present disclosure, any method or apparatus embodiment may be devoid of one or more process steps or components. In the present disclosure, embodiments employing negative limitations are expressly disclosed and considered a part of this disclosure.

Certain terminology and derivations thereof may be used in the present disclosure for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an embodiment “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number),” this means a range whose limit is the second number. For example, 25 to 100 mm means a range whose lower limit is 25 mm and upper limit is 100 mm.

Many suitable methods and corresponding materials to make each of the individual parts of embodiment apparatus are known in the art. According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as may be described herein-above may be used. Many suitable materials are known and available and can be selected and mixed depending on desired strength and flexibility, preferred manufacturing method and particular use, as will be apparent to a person of ordinary skill in the art.

Any element in a claim herein that does not explicitly state “means for” performing a specified function, or “step for” performing a specific function, is not to be interpreted as a “means” or “step” clause as specified in 35 U.S.C. § 112 (f). Specifically, any use of “step of” in the claims herein is not intended to invoke the provisions of 35 U.S.C. § 112 (f). Elements recited in means-plus-function format are intended to be construed in accordance with 35 U.S.C. § 112 (f).

Recitation in a claim of the term “first” with respect to a feature or element does not necessarily imply the existence of a second or additional such feature or element.

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim in this or any application claiming priority to this application require more features than those expressly recited in that claim. Rather, as the following claims reflect, inventive aspects may lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

According to an embodiment of the present invention, the system and method may be accomplished through the use of one or more computing devices. As depicted, for example, at least in FIG. 1, FIG. 2, FIG. 3, and FIG. 4, one of ordinary skill in the art would appreciate that an exemplary system appropriate for use with embodiments in accordance with the present application may generally include one or more of a Central processing Unit (CPU), Random Access Memory (RAM), a storage medium (e.g., hard disk drive, solid state drive, flash memory, cloud storage), an operating system (OS), one or more application software, a display element, one or more communications means, or one or more input/output devices/means. Examples of computing devices usable with embodiments of the present invention include, but are not limited to, proprietary computing devices, personal computers, mobile computing devices, tablet PCs, mini-PCs, servers or any combination thereof. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In various embodiments, communications means, data store(s), processor(s), or memory may interact with other components on the computing device, in order to effect the provisioning and display of various functionalities associated with the system and method detailed herein. One of ordinary skill in the art would appreciate that there are numerous configurations that could be utilized with embodiments of the present invention, and embodiments of the present invention are contemplated for use with any appropriate configuration.

According to an embodiment of the present invention, the communications means of the system may be, for instance, any means for communicating data over one or more networks or to one or more peripheral devices attached to the system. Appropriate communications means may include, but are not limited to, circuitry and control systems for providing wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description may set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a sequence of computational instructions or program instructions. It will be appreciated that a programmable apparatus (i.e., computing device) can receive such a computer program and, by processing the computational instructions thereof, produce a further technical effect.

A programmable apparatus may include one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these.

All such implementations are within the scope of the present disclosure. Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The embodiments disclosed herein may be summarized as follows.

### Embodiment 1

An apparatus configured to assign a job to a worker, comprising: a processor; a data communication interface, operably coupled with the processor; and, a memory that is not a transitory propagating signal, the memory operably connected to the processor and encoding computer readable instructions, including processor executable program instructions, the computer readable instructions accessible to the processor, wherein the processor executable instructions, when executed by the processor, cause the processor to perform operations comprising: receive an electronic message comprising a work request for an available worker to complete a job, wherein the work request comprises the job definition, and wherein the job definition comprises a requested job beginning location, a requested job ending location remote from the requested job beginning location, and a requested job completion time; choose a candidate worker remote from the job beginning location, wherein the candidate worker is selected from an available worker pool, and wherein the candidate worker is selected as a function of the available worker location, the requested job beginning location, and the requested job completion time; send an electronic message comprising assignment of the job to the selected candidate worker as the worker assigned the job; and, in response to receiving an electronic message comprising the assigned worker location within a predetermined radius of the job beginning location, send an electronic message comprising an indication of the assigned worker expected arrival time at the job beginning location.

### Embodiment 2

The apparatus of Embodiment 1, wherein the operations performed by the processor further comprise confirm job completion determined as a function of associating data captured from the job beginning location with data captured from the job ending location.

### Embodiment 3

The apparatus of Embodiment 1, wherein the available worker pool further comprises an available worker list constructed based on receiving an electronic message comprising worker identification.

### Embodiment 4

The apparatus of Embodiment 1, wherein the operations performed by the processor further comprise record an available worker location in response to receiving an electronic message comprising the available worker location.

### Embodiment 5

The apparatus of Embodiment 1, wherein choose a candidate worker selected from the available worker pool further comprises sending to a worker an electronic message comprising the work request.

### Embodiment 6

The apparatus of Embodiment 5, wherein the work request further comprises a plurality of jobs.

### Embodiment 7

The apparatus of Embodiment 5, wherein the electronic message comprising the work request is sent to one worker at a time selected from the available worker pool.

### Embodiment 8

The apparatus of Embodiment 7, wherein the operations performed by the processor further comprise in response to a determination the worker did not respond to the work request within a predetermined time period, send the work request to the next worker selected from the available worker pool in an order determined as a function of worker location.

### Embodiment 9

The apparatus of Embodiment 7, wherein the operations performed by the processor further comprise in response to receiving an electronic message comprising declining the work request, send the work request to the next worker selected from the available worker pool in an order determined as a function of worker location.

### Embodiment 10

The apparatus of Embodiment 1, wherein choose a candidate worker selected from the available worker pool further comprises receiving from the candidate worker an electronic message comprising acceptance of a work request.

### Embodiment 11

The apparatus of Embodiment 10, wherein the operations performed by the processor further comprise in response to receiving from the candidate worker an electronic message comprising acceptance of the work request, send to the candidate worker an electronic message comprising another work request for a different job.

### Embodiment 12

The apparatus of Embodiment 1, wherein choose a candidate worker selected from the available worker pool further comprises receiving an electronic message comprising declining a work request.

### Embodiment 13

The apparatus of Embodiment 1, wherein the operations performed by the processor further comprise send to a worker an electronic message comprising directions from the worker location to the job beginning location.

### Embodiment 14

The apparatus of Embodiment 1, wherein the operations performed by the processor further comprise in response to receiving from the worker assigned to a job an electronic message comprising an indication the job is complete, confirm the job is complete based on determining the distance between the worker location and the job ending location exceeds a predetermined threshold distance.

### Embodiment 15

The apparatus of Embodiment 14, wherein confirm the job is complete further comprises receiving an electronic message comprising data captured from the job ending location.

### Embodiment 16

An apparatus configured to assign a job to a worker, comprising: a processor; a data communication interface, operably coupled with the processor; and, a memory that is not a transitory propagating signal, the memory operably connected to the processor and encoding computer readable instructions, including processor executable program instructions, the computer readable instructions accessible to the processor, wherein the processor executable instructions, when executed by the processor, cause the processor to perform operations comprising: receive an electronic message comprising a work request for an available worker to complete a job, wherein the work request comprises the job definition, wherein the job definition comprises a requested job beginning location, a requested job ending location remote from the requested job beginning location, and a requested job completion time, wherein the job comprises transporting a substantially movable object from the job beginning location to the job ending location, wherein the substantially movable object comprises encoded data identifying the substantially movable object, wherein the job ending location comprises an object substantially fixed in the job ending location, and wherein the object substantially fixed in the job ending location comprises encoded data identifying the substantially fixed object; choose a candidate worker remote from the job beginning location, wherein the candidate worker is selected from an available worker pool, and wherein the candidate worker is selected as a function of the available worker location, the requested job beginning location, and the requested job completion time; send an electronic message comprising assignment of the job to the selected candidate worker as the worker assigned the job; in response to receiving, from the worker assigned the job, an electronic message comprising data captured from the job beginning location, and upon a determination the data captured from the job beginning location corresponds with the requested job beginning location, send an electronic message comprising an indication the job started; in response to receiving, from the worker assigned the job, an electronic message comprising data captured from the job beginning location, and, an electronic message comprising data captured from the job ending location, confirm job completion status determined as a function of associating the data captured from the job beginning location with the data captured from the job ending location and with data associated with the work request; and, upon a determination the job completed, send an electronic message comprising an indication the job completed.

### Embodiment 17

The apparatus of Embodiment 16, wherein confirm job completion status determined as a function of associating the data captured from the job beginning location with the data captured from the job ending location further comprises associating encoded data identifying the substantially movable object captured from the job beginning location with encoded data identifying the substantially movable object captured from the job ending location.

### Embodiment 18

The apparatus of Embodiment 16, wherein confirm job completion status determined as a function of associating the data captured from the job beginning location with the data captured from the job ending location further comprises associating encoded data identifying the substantially movable object captured from the job beginning location and job ending location with encoded data identifying the substantially fixed object captured from the job ending location.

### Embodiment 19

The apparatus of Embodiment 16, wherein encoded data further comprises optical code.

### Embodiment 20

The apparatus of Embodiment 16, wherein the substantially movable object is a trash receptacle and the substantially fixed object is a mailbox.

### Embodiment 21

The apparatus of Embodiment 16, wherein data captured further comprises image data and associating the data captured further comprises comparing image data text extracted from the image data based on image processing.

### Embodiment 22

An apparatus configured to coordinate worker job completion, comprising: a processor; a data communication interface, operably coupled with the processor; a user interface, operably coupled with the processor; a location sensor, operably coupled with the processor; an imaging sensor, operably coupled with the processor; and, a memory that is not a transitory propagating signal, the memory operably connected to the processor and encoding computer readable instructions, including processor executable program instructions, the computer readable instructions accessible to the processor, wherein the processor executable instructions, when executed by the processor, cause the processor to perform operations comprising: send an electronic message comprising an indication the worker is available to complete a job; send an electronic message comprising the worker location captured from the location sensor; receive an electronic message comprising a work request, wherein the work request comprises a job definition, and wherein the job definition comprises a requested job beginning location, a requested job ending location remote from the requested job beginning location, and a requested job completion time; present, via the user interface, the work request to the worker; in response to receiving, via the user interface, an indication the worker accepted the job, send an electronic message comprising an indication the worker accepted the job; upon a determination the worker location captured from the location sensor is less than or equal to a predetermined minimum distance from the job beginning location, send an electronic message comprising an indication the worker will be arriving to begin the job; upon receiving, via the user interface, an indication the worker arrived to begin the job, send an electronic message comprising data captured from the job beginning location; and, upon receiving, via the user interface, an indication the worker completed the job, send an electronic message comprising data captured from the job ending location.

### Embodiment 23

The apparatus of Embodiment 22, wherein data captured further comprises optical code data captured from the imaging sensor.

### Embodiment 24

The apparatus of Embodiment 22, wherein the operations performed by the processor further comprise upon receiving, via the user interface, an indication the worker arrived to begin the job, send an electronic message comprising data captured from the job ending location.

### Embodiment 25

The apparatus of Embodiment 22, wherein the operations performed by the processor further comprise upon a determination the worker location captured from the location sensor is greater than a predetermined minimum distance from the job ending location, present, via the user interface, a user operable control configured to permit the worker to indicate the worker completed the job.

### Embodiment 26

An apparatus configured to coordinate a user request for a worker to complete a job, comprising: a processor; a data communication interface, operably coupled with the processor; a user interface, operably coupled with the processor; a location sensor, operably coupled with the processor; an imaging sensor, operably coupled with the processor; and, a memory that is not a transitory propagating signal, the memory operably connected to the processor and encoding computer readable instructions, including processor executable program instructions, the computer readable instructions accessible to the processor, wherein the processor executable instructions, when executed by the processor, cause the processor to perform operations comprising: send an electronic message comprising a work request received via the user interface for an available worker to complete a job, wherein the work request comprises the job definition, wherein the job definition comprises a requested job beginning location determined from the location sensor, a requested job ending location remote from the requested job beginning location, and a requested job completion time, wherein the job comprises transporting a substantially movable object from the job beginning location to the job ending location, wherein the substantially movable object comprises encoded data identifying the substantially movable object, wherein the job ending location comprises an object substantially fixed in the job ending location, and wherein the object substantially fixed in the job ending location comprises encoded data identifying the substantially fixed object; send an electronic message comprising data captured from the job beginning location; send an electronic message comprising data captured from the job ending location; receive an electronic message comprising an indication the job has been assigned to a worker; receive an electronic message comprising an indication the worker will be arriving to begin the job; and, receive an electronic message comprising an indication the job has been completed.

### Embodiment 27

The apparatus of Embodiment 26, wherein the work request further comprises image data captured from the job ending location by the imaging sensor.

### Embodiment 28

The apparatus of Embodiment 26, wherein the work request further comprises encoded data captured from the substantially movable object located at the job beginning location.

### Embodiment 29

The apparatus of Embodiment 26, wherein the work request further comprises encoded data captured from a plurality of substantially movable objects located at the job beginning location.

### Embodiment 30

The apparatus of Embodiment 26, wherein: the encoded data further comprises optical code, the substantially movable object is a trash receptacle, and the substantially fixed object is a mailbox.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. An apparatus configured to assign a job to a worker, comprising:
a processor;
a data communication interface, operably coupled with the processor; and,
a memory that is not a transitory propagating signal, the memory operably connected to the processor and encoding computer readable instructions, including processor executable program instructions, the computer readable instructions accessible to the processor, wherein the processor executable instructions, when executed by the processor, cause the processor to perform operations comprising:
receive an electronic message comprising a work request for an available worker to complete a job, wherein the work request comprises the job definition, and wherein the job definition comprises a requested job beginning location, a requested job ending location remote from the requested job beginning location, and a requested job completion time;
choose a candidate worker remote from the job beginning location, wherein the candidate worker is selected from an available worker pool, and wherein the candidate worker is selected as a function of the available worker location, the requested job beginning location, and the requested job completion time;
send an electronic message comprising assignment of the job to the selected candidate worker as the worker assigned the job; and,
in response to receiving an electronic message comprising the assigned worker location within a predetermined radius of the job beginning location, send an electronic message comprising an indication of the assigned worker expected arrival time at the job beginning location.

2. The apparatus of claim 1, wherein the operations performed by the processor further comprise confirm job completion determined as a function of associating data captured from the job beginning location with data captured from the job ending location.

3. The apparatus of claim 1, wherein the available worker pool further comprises an available worker list constructed based on receiving an electronic message comprising worker identification.

4. The apparatus of claim 1, wherein the operations performed by the processor further comprise record an available worker location in response to receiving an electronic message comprising the available worker location.

5. The apparatus of claim 1, wherein choose a candidate worker selected from the available worker pool further comprises sending to a worker an electronic message comprising the work request.

6. The apparatus of claim 5, wherein the work request further comprises a plurality of jobs.

7. The apparatus of claim 5, wherein the electronic message comprising the work request is sent to one worker at a time selected from the available worker pool.

8. The apparatus of claim 7, wherein the operations performed by the processor further comprise in response to a determination the worker did not respond to the work request within a predetermined time period, send the work request to the next worker selected from the available worker pool in an order determined as a function of worker location.

9. The apparatus of claim 7, wherein the operations performed by the processor further comprise in response to receiving an electronic message comprising declining the work request, send the work request to the next worker selected from the available worker pool in an order determined as a function of worker location.

10. The apparatus of claim 1, wherein choose a candidate worker selected from the available worker pool further comprises receiving from the candidate worker an electronic message comprising acceptance of a work request.

11. The apparatus of claim 10, wherein the operations performed by the processor further comprise in response to receiving from the candidate worker an electronic message comprising acceptance of the work request, send to the candidate worker an electronic message comprising another work request for a different job.

12. The apparatus of claim 1, wherein choose a candidate worker selected from the available worker pool further comprises receiving an electronic message comprising declining a work request.

13. The apparatus of claim 1, wherein the operations performed by the processor further comprise send to a worker an electronic message comprising directions from the worker location to the job beginning location.

14. The apparatus of claim 1, wherein the operations performed by the processor further comprise in response to receiving from the worker assigned to a job an electronic message comprising an indication the job is complete, confirm the job is complete based on determining the distance between the worker location and the job ending location exceeds a predetermined threshold distance.

15. The apparatus of claim 14, wherein confirm the job is complete further comprises receiving an electronic message comprising data captured from the job ending location.

16. An apparatus configured to assign a job to a worker, comprising:
a processor;
a data communication interface, operably coupled with the processor; and,
a memory that is not a transitory propagating signal, the memory operably connected to the processor and encoding computer readable instructions, including processor executable program instructions, the computer readable instructions accessible to the processor, wherein the processor executable instructions, when executed by the processor, cause the processor to perform operations comprising:
receive an electronic message comprising a work request for an available worker to complete a job, wherein the work request comprises the job definition, wherein the job definition comprises a requested job beginning location, a requested job ending location remote from the requested job beginning location, and a requested job completion time, wherein the job comprises transporting a substantially movable object from the job beginning location to the job ending location, wherein the substantially movable object comprises encoded data identifying the substantially movable object, wherein the job ending location comprises an object substantially fixed in the job ending location, and wherein the object substantially fixed in the job ending location comprises encoded data identifying the substantially fixed object;
choose a candidate worker remote from the job beginning location, wherein the candidate worker is selected from an available worker pool, and wherein the candidate worker is selected as a function of the available worker location, the requested job beginning location, and the requested job completion time;
send an electronic message comprising assignment of the job to the selected candidate worker as the worker assigned the job;
in response to receiving, from the worker assigned the job, an electronic message comprising data captured from the job beginning location, and upon a determination the data captured from the job beginning location corresponds with the requested job beginning location, send an electronic message comprising an indication the job started;
in response to receiving, from the worker assigned the job, an electronic message comprising data captured from the job beginning location, and, an electronic message comprising data captured from the job ending location, confirm job completion status determined as a function of associating the data captured from the job beginning location with the data captured from the job ending location and with data associated with the work request; and,
upon a determination the job completed, send an electronic message comprising an indication the job completed.

17. The apparatus of claim 16, wherein confirm job completion status determined as a function of associating the data captured from the job beginning location with the data captured from the job ending location further comprises associating encoded data identifying the substantially movable object captured from the job beginning location with encoded data identifying the substantially movable object captured from the job ending location.

18. The apparatus of claim 16, wherein confirm job completion status determined as a function of associating the data captured from the job beginning location with the data captured from the job ending location further comprises associating encoded data identifying the substantially movable object captured from the job beginning location and job ending location with encoded data identifying the substantially fixed object captured from the job ending location.

19. The apparatus of claim 16, wherein encoded data further comprises optical code.

20. The apparatus of claim 16, wherein the substantially movable object is a trash receptacle and the substantially fixed object is a mailbox.

21. The apparatus of claim 16, wherein data captured further comprises image data and associating the data captured further comprises comparing image data text extracted from the image data based on image processing.

22. An apparatus configured to coordinate worker job completion, comprising:
a processor;
a data communication interface, operably coupled with the processor;
a user interface, operably coupled with the processor;
a location sensor, operably coupled with the processor;
an imaging sensor, operably coupled with the processor; and,
a memory that is not a transitory propagating signal, the memory operably connected to the processor and encoding computer readable instructions, including processor executable program instructions, the computer readable instructions accessible to the processor, wherein the processor executable instructions, when executed by the processor, cause the processor to perform operations comprising:
send an electronic message comprising an indication the worker is available to complete a job;
send an electronic message comprising the worker location captured from the location sensor;
receive an electronic message comprising a work request, wherein the work request comprises a job definition, and wherein the job definition comprises a requested job beginning location, a requested job ending location remote from the requested job beginning location, and a requested job completion time;
present, via the user interface, the work request to the worker;
in response to receiving, via the user interface, an indication the worker accepted the job, send an electronic message comprising an indication the worker accepted the job;
upon a determination the worker location captured from the location sensor is less than or equal to a predetermined minimum distance from the job beginning location, send an electronic message comprising an indication the worker will be arriving to begin the job;
upon receiving, via the user interface, an indication the worker arrived to begin the job, send an electronic message comprising data captured from the job beginning location; and,
upon receiving, via the user interface, an indication the worker completed the job, send an electronic message comprising data captured from the job ending location.

23. The apparatus of claim 22, wherein data captured further comprises optical code data captured from the imaging sensor.

24. The apparatus of claim 22, wherein the operations performed by the processor further comprise upon receiving, via the user interface, an indication the worker arrived to begin the job, send an electronic message comprising data captured from the job ending location.

25. The apparatus of claim 22, wherein the operations performed by the processor further comprise upon a determination the worker location captured from the location sensor is greater than a predetermined minimum distance from the job ending location, present, via the user interface, a user operable control configured to permit the worker to indicate the worker completed the job.

26. An apparatus configured to coordinate a user request for a worker to complete a job, comprising:
a processor;
a data communication interface, operably coupled with the processor;
a user interface, operably coupled with the processor;
a location sensor, operably coupled with the processor;
an imaging sensor, operably coupled with the processor; and,
a memory that is not a transitory propagating signal, the memory operably connected to the processor and encoding computer readable instructions, including processor executable program instructions, the computer readable instructions accessible to the processor, wherein the processor executable instructions, when executed by the processor, cause the processor to perform operations comprising:
send an electronic message comprising a work request received via the user interface for an available worker to complete a job, wherein the work request comprises the job definition, wherein the job definition comprises a requested job beginning location determined from the location sensor, a requested job ending location remote from the requested job beginning location, and a requested job completion time, wherein the job comprises transporting a substantially movable object from the job beginning location to the job ending location, wherein the substantially movable object comprises encoded data identifying the substantially movable object, wherein the job ending location comprises an object substantially fixed in the job ending location, and wherein the object substantially fixed in the job ending location comprises encoded data identifying the substantially fixed object;
send an electronic message comprising data captured from the job beginning location;
send an electronic message comprising data captured from the job ending location;
receive an electronic message comprising an indication the job has been assigned to a worker;
receive an electronic message comprising an indication the worker will be arriving to begin the job; and,
receive an electronic message comprising an indication the job has been completed.

27. The apparatus of claim 26, wherein the work request further comprises image data captured from the job ending location by the imaging sensor.

28. The apparatus of claim 26, wherein the work request further comprises encoded data captured from the substantially movable object located at the job beginning location.

29. The apparatus of claim 26, wherein the work request further comprises encoded data captured from a plurality of substantially movable objects located at the job beginning location.

30. The apparatus of claim 26, wherein: the encoded data further comprises optical code, the substantially movable object is a trash receptacle, and the substantially fixed object is a mailbox.
